(19) United States
(12) Patent Application Publication
(10) Pub. No.: US 2026/0263935 A1
(43) Pub. Date: Sep. 10, 2026

(54) ONE OR MORE COMPUTER-READABLE STORAGE MEDIA, INFORMATION PROCESSING SYSTEM, AND COMPUTER-IMPLEMENTED METHOD

(71) Applicant: NINTENDO CO., LTD., Kyoto (JP)

(72) Inventors: Shinya HIRATAKE, Kyoto (JP); Kento SAKAI, Kyoto (JP); Ryuta CHIBA, Kyoto (JP)

(21) Appl. No.: 19/468,646

(22) Filed: Feb. 3, 2026

(30) Foreign Application Priority Data
Feb. 28, 2025 (JP) 2025-031364

(51) Int. Cl. A63F 13/577; A63F 13/52

(52) U.S. Cl. CPC A63F 13/577; A63F 13/52

(57) ABSTRACT

An example of an information processing system controls movement of a player object in a virtual space, based on an operation input at a position on a voxel mesh, when the player object is on the voxel mesh. The information processing system generates a first voxel update range in front of the player object, and decreases the densities of voxels corresponding to the first voxel update range. The information processing system causes the player object to perform a first action in response to a first instruction. The information processing system generates a second voxel update range continuously at positions passed by the player object through the first action, and increases the densities of voxels corresponding to the second voxel update range.

### CROSS REFERENCE TO RELATED APPLICATION

This application claims priority to Japanese Patent Application No. 2025-031364, filed on Feb. 28, 2025, the entire contents of which are incorporated herein by reference.

### FIELD

The technique shown herein relates to one or more computer-readable media, an information processing system, and a computer-implemented method for generating an object in a virtual space by using voxel data.

### BACKGROUND AND SUMMARY

Conventionally, an object is managed using voxel data, and a mesh of the object is generated in a virtual space, based on the voxel data.

It is desired to provide a novel game using voxel data.

Therefore, the present application discloses one or more computer-readable media, an information processing system, and a computer-implemented method for executing a novel game using voxel data.
(1)

An example of one or more non-transitory computer-readable storage media having stored therein instructions that, when executed, cause one or more processors to execute information processing comprising:
updating, based on game processing, voxel data which is defined in a virtual space and in which at least a density is set for each of a plurality of voxels, the density indicating a degree of occupation of a content in a space defined by the voxel;
updating a voxel mesh which is a mesh corresponding to the voxel data, and vertex coordinates of which are determined based on at least the density included in the voxel data; and
in the game processing,
   when a player object in the virtual space is on the voxel mesh, controlling movement of the player object based on an operation input at a position on the voxel mesh,
   generating a first voxel update range in front of the player object, and decreasing the densities of voxels corresponding to the first voxel update range,
   causing the player object to perform a first action in response to a first instruction based on the operation input, and
   generating a second voxel update range continuously at positions passed by the player object through the first action, and increasing the densities of voxels corresponding to the second voxel update range.

According to the configuration of the above (1), a novel game in which the voxel mesh dynamically deforms in response to movement of the player object can be provided.
(2)

In the configuration of the above (1), the game processing may be for a racing game in which the player object completes a plurality of laps around an annular course in a field within the virtual space.

According to the configuration of the above (2), the player object can move on the voxel mesh updated according to its first action. Thus, the strategy of the racing game can be improved.
(3)

In the configuration of the above (2), the course in the field may include a ground object having a mesh other than the voxel mesh. The voxel data may be defined in at least a range above the ground object in the virtual space. The information processing may further comprise controlling movement of the player object in the virtual space, based on an operation input at the position on the ground object, when the player object is on the ground object.

According to the configuration of the above (3), the field suitable for the racing game can be provided by the ground object.
(4)

In the configuration of the any one of above (1) to (3), in the voxel data, a material indicating the type of the content may be set for each of the plurality of voxels. The information processing may further comprise: generating or updating a material of the voxel mesh by determining the material based on at least the material included in the voxel data; updating, to a first material, the material of a voxel the density of which is increased based on the second voxel update range; and accelerating the player object when the player object is on the voxel mesh the material of which is the first material.

According to the configuration of the above (4), the player object can advantageously progress the game by moving on the voxel mesh generated by the first action. Thus, the strategy of the game can be further improved.
(5)

In the configuration of the any one of above (1) to (4), in the voxel data, a material indicating the type of the content may be set for each of the plurality of voxels. The information processing may further comprise: generating or updating a material of the voxel mesh by determining the material based on at least the material included in the voxel data; and when the material of the voxel mesh in a traveling direction of the player object is a second material, reducing a movement speed of the player object in the movement control more than when the material of the voxel mesh is a third material.

According to the configuration of the above (5), the strategy of the game can be further improved.
(6)

In the configuration of the above (5), the information processing may further comprise, when a first event has occurred during the game processing, swapping the type of the content indicated by the second material and the type of the content indicated by the third material with each other.

According to the configuration of the above (6), the strategy of the game can be further improved. Furthermore, the process of swapping the materials of voxel meshes can be realized with less processing load.
(7)

In the configuration of the any one of above (1) to (6), the information processing may further comprise generating the second voxel update range after a certain period has elapsed from when the player object passed.

According to the configuration of the above (7), the risk of contact of the player object with the updated voxel mesh can be reduced.
(8)

In the configuration of the any one of above (1) to (7), the first action may be an action including at least a jump in a traveling direction. The information processing further comprises: during a first period after start of the first action, setting, as the second voxel update range, a range obtained by excluding a portion, of a third voxel update range set at a position passed by the player object, located above a plane obtained by a certain angle inclining a plane from the start position of the first action to the current position of the player object; and after the first period has elapsed, setting the third voxel update range as the second voxel update range.

According to the configuration of the above (8), the player object can more easily enter the voxel mesh updated according to the setting of the second voxel update range.
(9)

In the configuration of the any one of above (1) to (8), the information processing may further comprise, when the first action is started, generating a fourth voxel update range outside the second voxel update range, and increasing the densities of voxels corresponding to the fourth voxel update range.

According to the configuration of the above (9), the position of the voxel mesh updated according to the setting of the second voxel update range can be made easier for the player to recognize. In addition, the player object can more easily enter the voxel mesh.
(10)

In the configuration of the any one of above (1) to (9), the voxel mesh may include a collision mesh used for collision determination with the player object and a display mesh rendered based on a virtual camera, or serves both as the collision mesh and as the display mesh. In the voxel data, a material indicating the type of the content may be set for each of the plurality of voxels. The information processing further comprises: determining a material of the collision mesh, based on at least the material included in the voxel data; and using the collision mesh as the display mesh, rendering the virtual space including the display mesh, based on a texture corresponding to vertex coordinates of the display mesh and the material of the display mesh.

According to the configuration of the above (10), collision determination and rendering can be performed using the voxel mesh updated according to the setting of the voxel update range.
(11)

In the configuration of the any one of above (1) to (9), the voxel mesh may be a collision mesh used for collision determination with the player object. In the voxel data, a material indicating the type of the content may be set for each of the plurality of voxels. The information processing further comprises: generating or updating a display mesh which corresponds to the voxel data and is rendered based on a virtual camera, by determining vertex coordinates of the display mesh, based on at least the density included in the voxel data, and determining a material of the display mesh, based on at least the material included in the voxel data; and rendering the virtual space including the display mesh, based on a texture corresponding to the vertex coordinates of the display mesh and the material of the display mesh.

According to the configuration of the above (11), collision determination can be performed using the voxel mesh updated according to the setting of the voxel update range.

The present specification discloses examples of an information processing apparatus and an information processing system that execute the processes in the above (1) to (11). Furthermore, the present specification discloses an example of a computer-implemented method that executes the processes in the above (1) to (11) in the information processing system.

According to the storage media, the information processing system, the information processing apparatus, or the computer-implemented method, a novel game using voxel data can be provided.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a view showing an example of voxel data;

FIG. 12 is a view showing an example of material data;

FIG. 13 is a view showing an example of a game space when an update event has occurred;

FIG. 14 is a view showing an example of an update range;

FIG. 15 is a view showing an example of a method for setting vertices;

FIG. 16 is a view showing an example of a method for determining a material of a vertex;

FIG. 17 is a view showing an example of vertex simplification;

FIG. 18 is a view showing an example of conditions regarding materials;

FIG. 19 is a view showing an example of a mesh generated based on vertices;

FIG. 20 is a view showing an example of division of a quadrangle forming a mesh into two triangles;

FIG. 21 is a view showing an example of a method for determining materials of polygons forming a display mesh;

FIG. 22 is a view showing an example of materials set for vertices of adjacent two polygons;

FIG. 23 is a view showing an example of application of textures to polygons;

FIG. 24 is a view showing an example of a method for determining materials of polygons forming a determination mesh;

FIG. 25 is a view showing an example of a game image representing a state in which a player character moves on a terrain object;

FIG. 26 is a view showing an example of a game image representing a state in which the player character pulls out a fragment object from the terrain object;

FIG. 27 is a view showing an example of a game image representing a state in which a fragment object is generated because the player character has destroyed the terrain object;

FIG. 28 is a view showing an example of a game image in a state where the player character can perform a throwing action;

FIG. 29 is a view showing an example of a game image after a change is added to the terrain object because a fragment object has come into contact with the terrain object shown in FIG. 28;

FIG. 30 is a view showing an example of a game image displayed on a non-limiting game system;

FIG. 31 is a view showing an example of a game image representing a player object performing a generation action;

FIG. 32 is a view showing an example of a voxel update range that is set at a point when one frame has elapsed from when a generation action was started;

FIG. 33 is a view showing an example of a voxel update range that is set at a point when two frames have elapsed from when a generation action was started;

FIG. 34 is a view showing an example of a voxel update range that is set after a certain time has elapsed from when a generation action was started;

FIG. 35 is a view showing an example of a game image after a traveling road object has been generated;

FIG. 36 is a view showing an example of a game image when a player object moves on a traveling road object;

FIG. 37 is a view showing an example of game images before and after swapping of a soil object and a mud object;

FIG. 38 is a view showing an example of various data used for information processing in the non-limiting game system;

FIG. 39 is a flowchart showing an example of a flow of game processing executed by the non-limiting game system;

FIG. 40 is a sub flowchart showing an example of a specific flow of a speed calculation process in step S2 shown in FIG. 39;

FIG. 41 is a sub flowchart showing an example of a specific flow of a voxel update process in step S3 shown in FIG. 39;

FIG. 42 is a sub flowchart showing an example of a specific flow of the voxel update process in step S3 shown in FIG. 39; and

FIG. 43 is a sub flowchart showing an example of a specific flow of a player object control process in step S10 shown in FIG. 39.

### DETAILED DESCRIPTION OF NON-LIMITING EXAMPLE EMBODIMENTS

### 1. Configuration of Game System

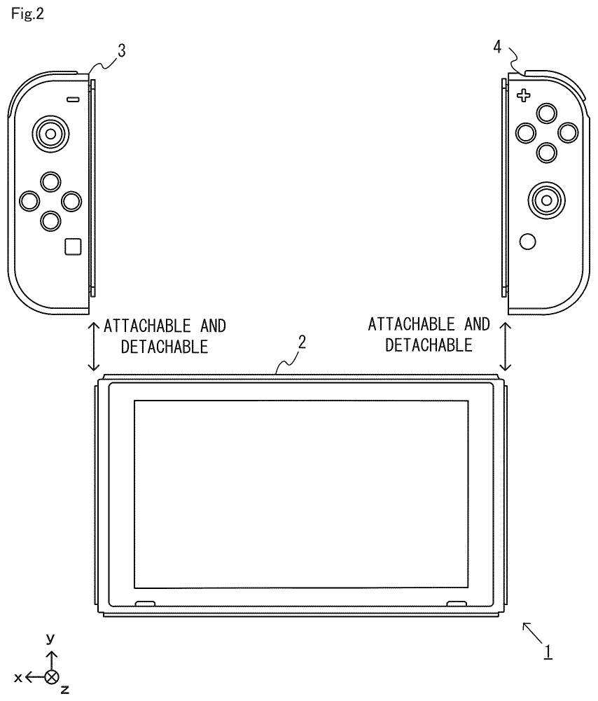

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

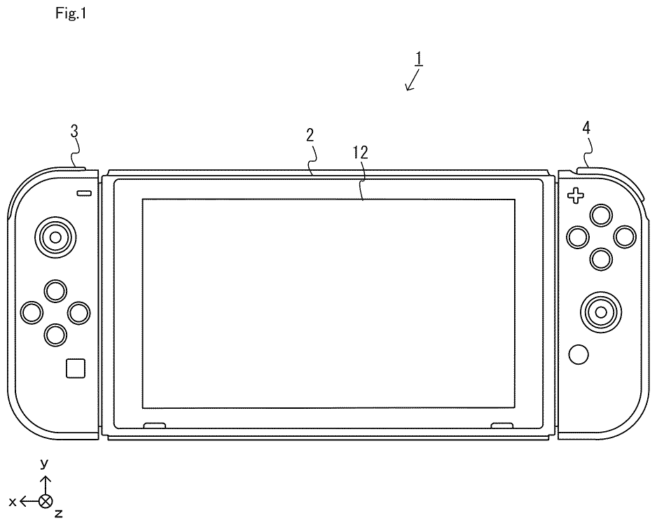

FIG. 1 is a diagram showing an example of the state in which the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state in which each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

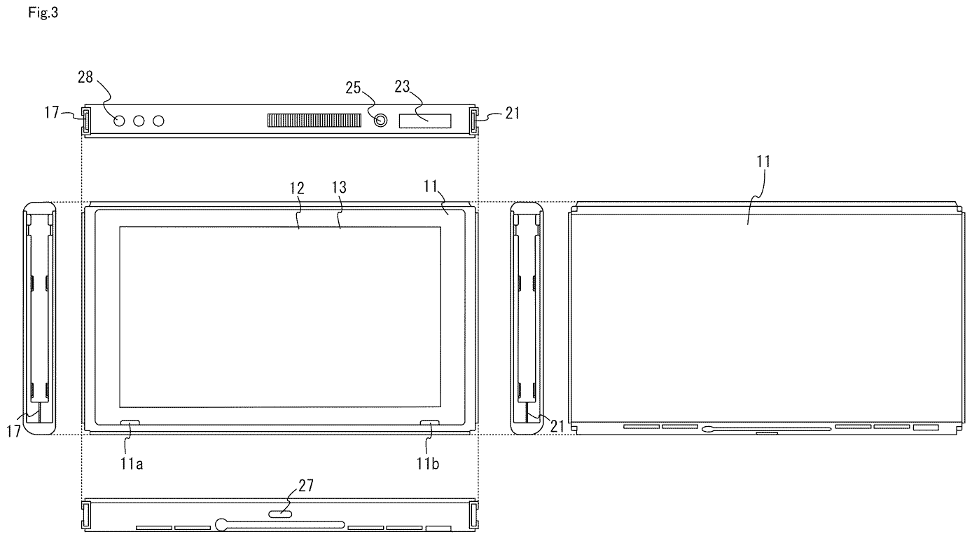

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

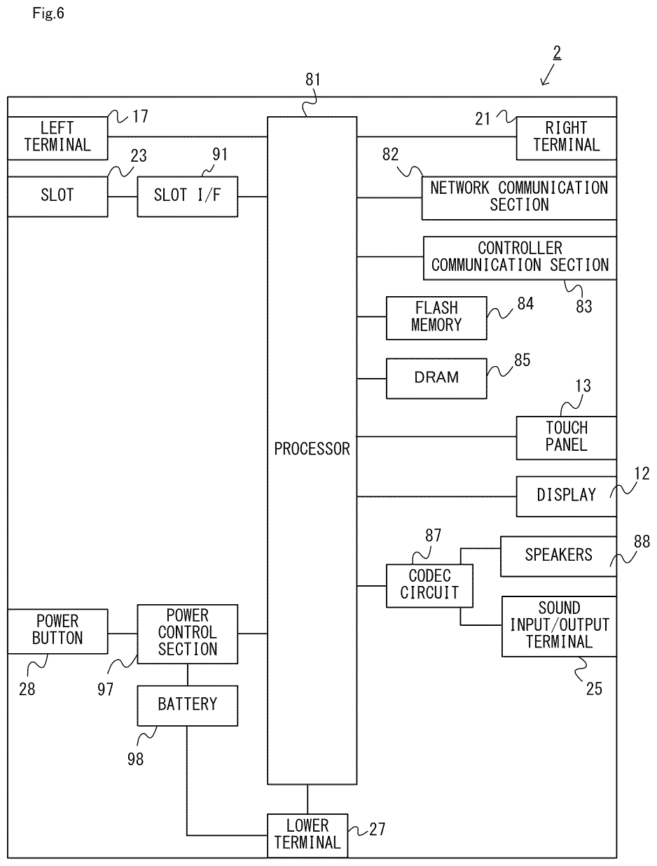

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

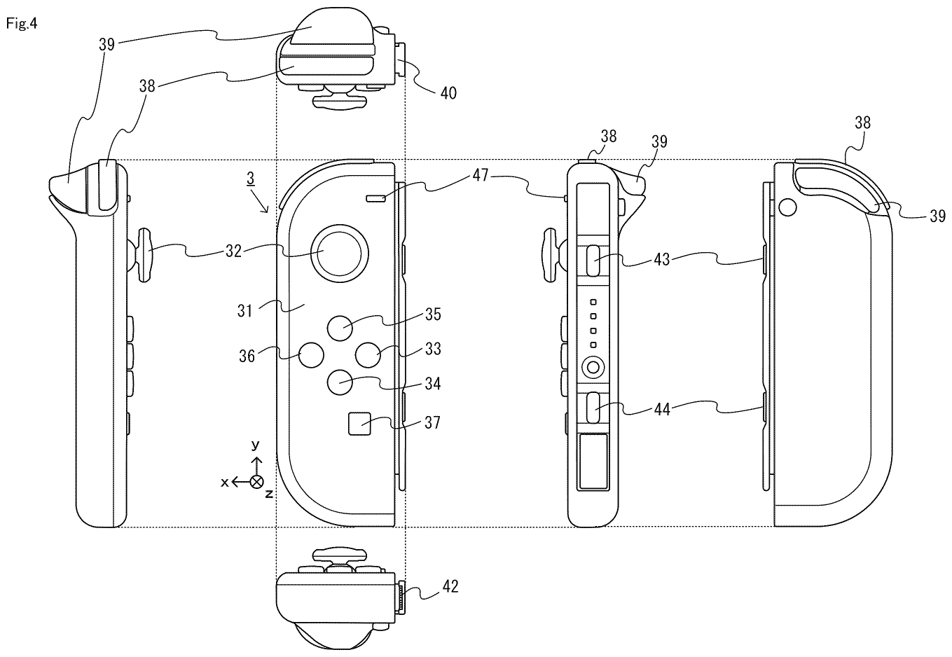

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

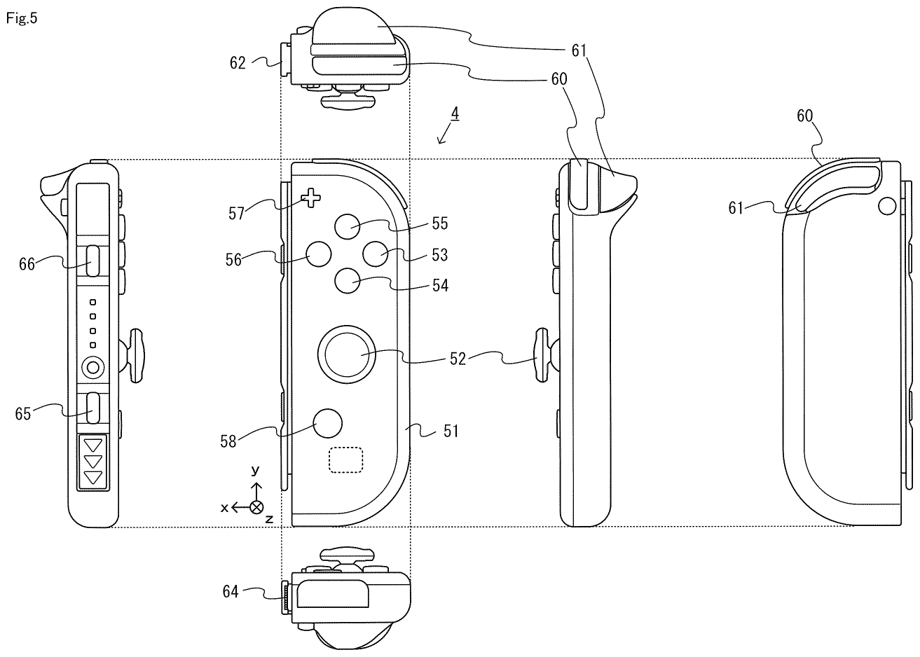

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage (for example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

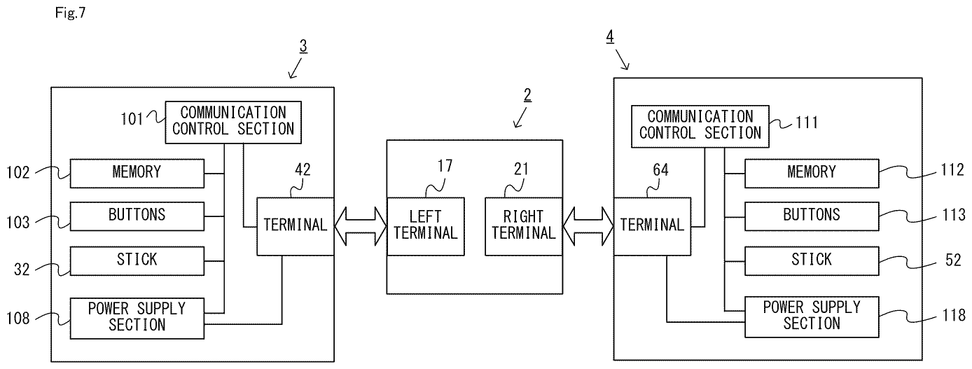

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### 2. Outline of Process on Game System

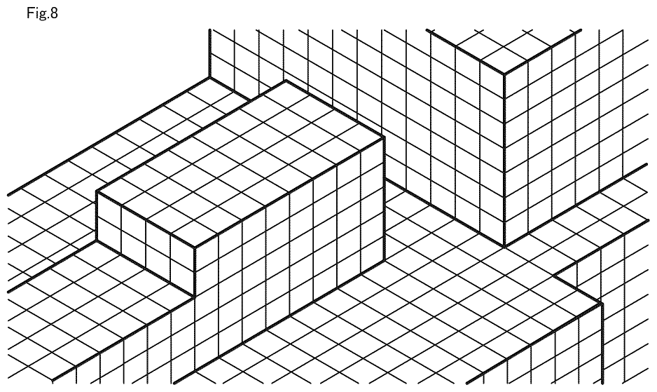

Next, referring to FIG. 8 to FIG. 29, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a stationary monitor.

### 2-1. Voxel

In the present embodiment, for some objects in the game space, the shape is defined by voxel data. Here, voxels are rectangular parallelepiped (more specifically, cubic) regions arranged in a grid pattern in the game space, and voxel data is data indicating information regarding the voxels. Hereinafter, an object whose shape is defined by voxel data will be referred to as a “voxel object”. In the present embodiment, the game system 1 stores voxel data for a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

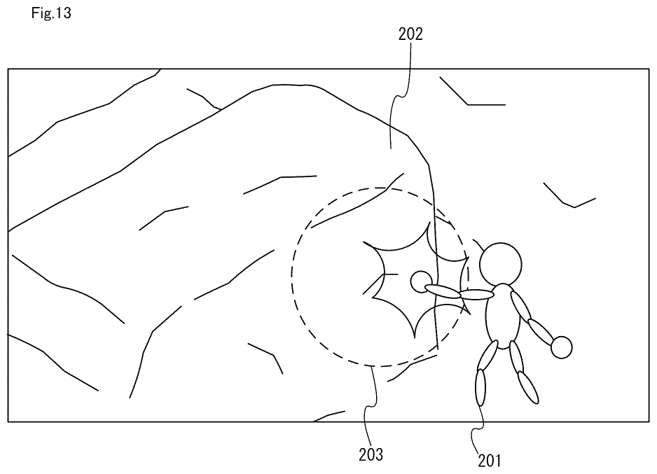

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the present embodiment, in practice, a voxel object is generated (e.g., based on voxel data) by such a rule that results in a terrain object having a complicated shape, such as a terrain object shown in FIG. 13 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 13 based on the object data.

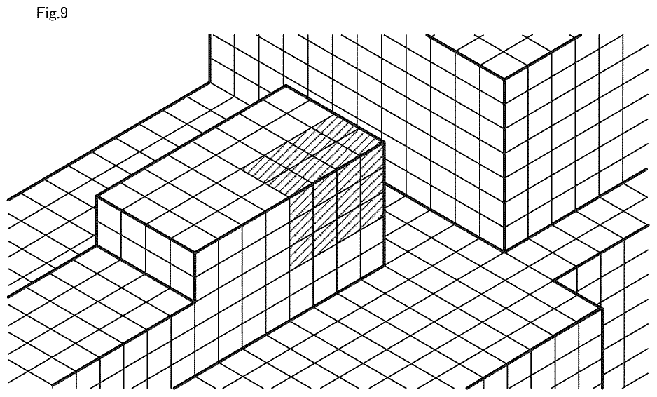

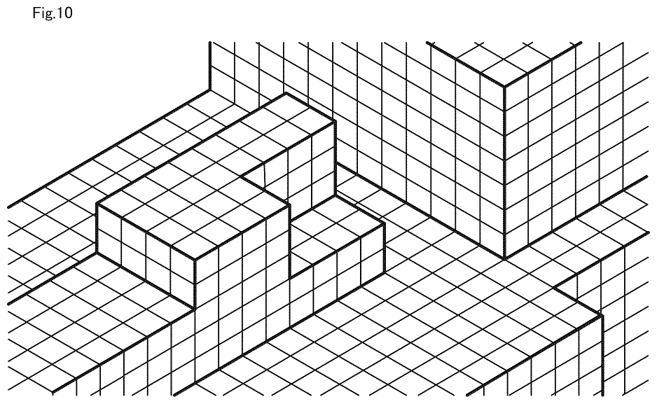

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

In the exemplary embodiment, voxels are defined in the entire game space (e.g., a voxel space in which voxels are set corresponds to the entire game space). However, the voxel space may not necessarily be set over the entire game space, and may be set in a certain area in the game space. If the voxel space is set in a certain area in the game space, the shape of the voxel object is defined by voxel data regarding voxels in the voxel space, and the position of the voxel object in the game space is defined by the position of the voxel space in the game space. The game space may include a main voxel space that is set over the entire game space, and a sub voxel space that is set in a certain area in the game space. In this case, the game system 1 stores therein the voxel data for each voxel space.

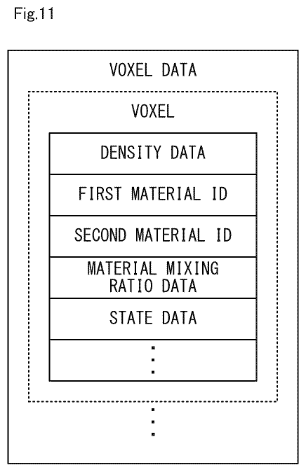

FIG. 11 shows an example of voxel data. The voxel data includes density data, a first material ID, a second material ID, material mixing ratio data, and state data, for each voxel defined in the game space. In the voxel data according to the exemplary embodiment, these pieces of data are set for each voxel.

The density data indicates a density that is an index used for defining the shape of a voxel object based on the voxel (specifically, the shape defined by a mesh described below). As will be described in detail below, the position and shape of the surface of the voxel object (e.g., the mesh described below) are determined based on the density.

In the exemplary embodiment, the density can take an integer value in a range from a lower limit value (e.g., 0) to an upper limit value (e.g., 255). In the exemplary embodiment, the game system 1 determines a surface shape of the voxel object, based on the density such that the proportion of the volume that the area in the voxel object occupies in the voxel tends to be greater when the density value set for the voxel is higher, and the proportion tends to be smaller when the density value is lower. Thus, the density is an index that has an influence on the proportion of the volume that the area in the voxel object occupies in the voxel. The density can also be regarded as an index that indicates the degree of virtual occupation of the content (e.g., the virtual content of the voxel object) in the space of the voxel. For example, when the density is 0, the voxel is empty. When the density is 255, the entire space in the voxel is the content of the voxel object. When the density is a value between 0 and 255, the content of the voxel object occupies the space in the voxel based on (e.g., in a proportion according to) the value. The shape of the mesh, e.g., the surface shape of the voxel object, can be determined based on the density. The mesh can be regarded as the surface of a part, of a voxel, in which the content exists, or as a boundary between a part, of a voxel, in which the content exists and a part, of the voxel, in which the content does not exist. The volume that the area in the voxel object generated based on the density occupies may not necessarily be the volume that exactly matches the proportion indicated by the density. For example, the volume of the voxel object may differ between the method for generating a voxel object as shown in FIG. 8 and the method for generating a voxel object as shown in FIG. 13 even if these methods are based on the same density.

In other embodiments, the density may indicate either a state in which the volume of the area in the voxel object occupies the entire area in the voxel or a state in which the volume of the area in the voxel object is not included in the area in the voxel. For example, the density data may be data that can take only 0 or 1.

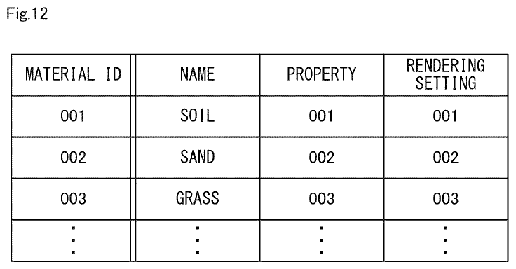

The first material ID and the second material ID are information indicating materials of the corresponding voxel. In the exemplary embodiment, a material such as sand, rock, or soil is set for a voxel. In the game system 1, multiple types of materials are prepared as materials that can be set for voxels (see material data shown in FIG. 12). In the exemplary embodiment, at most two materials out of the prepared multiple types of materials can be set for one voxel. The first material ID is an ID indicating a first material set for the voxel, and the second material ID is an ID indicating a second material set for the voxel. As will be described in detail below, a material of a voxel object (e.g., a material to be set for a polygon of the voxel object) is determined based on the materials set for voxels.

As described above, in the exemplary embodiment, the voxel data includes the ID indicating the material. However, in other embodiments, the voxel data may have a data structure that includes data directly indicating the details of the material (e.g., information on the name, property, and rendering setting described below).

The material mixing ratio data is an example of data indicating a ratio of materials in the voxel. In the exemplary embodiment, since at most two material IDs are set for one voxel, the material mixing ratio data, which indicates the ratio of one of the material indicated by the first material ID and the material indicated by the second material ID, can also indicate the ratio of the other material. In the exemplary embodiment, it is assumed that the material mixing ratio is a value indicating the ratio of the second material to the entire material consisting of the first material and the second material. The value is 0 or more and 1 or less. For example, if the material mixing ratio set for a certain voxel is 0.4, this indicates that the voxel is composed of the first material and the second material in the ratio of 0.6:0.4. As will be described in detail below, the appearance and property of the voxel object are determined based on the materials. The material mixing ratio is used to determine the appearance and property of the voxel object. In other embodiments, the material mixing ratio may be a value indicating the proportion of the first material. The ratio of the materials in the voxel may be indicated by the values of the proportions of the materials. In particular, in other embodiments, if the number of settable types of materials is not limited to two at most and three or more types of materials can be set, the ratio of the materials in the voxel is indicated by a plurality of values respectively indicating the proportions of the materials.

In the exemplary embodiment, two types of materials may not necessarily be set for a voxel, and one type of material may be set. For example, if one type of material is set for a certain voxel, the first material ID indicates this material, and the material mixing ratio is set at 0.

The state data indicates a state that is set for the corresponding voxel. The specific content of state data and the number of types thereof are discretionary. In the exemplary embodiment, the state data includes data indicating the amount of damage set on the voxel. In other embodiments, the state data may include data indicating whether or not the voxel is wet (and its extent), for example.

As described above, in the exemplary embodiment, since the voxel data includes the material ID, the game system 1 stores therein material data that defines the content of the material indicated by the material ID. FIG. 12 shows an example of the material data. As shown in FIG. 12, in the material data according to the exemplary embodiment, for each material, a material ID is associated with information on a name, a property, and rendering setting that are set for the material.

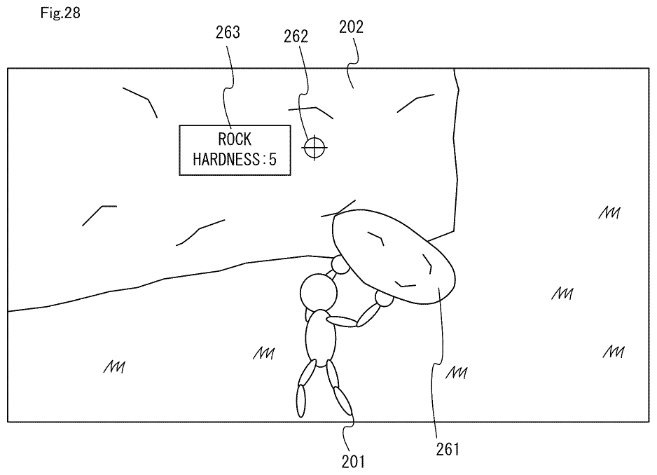

The name included in the material data is a name (e.g., soil, sand, grass, etc.) set for the material. As will be described in detail below, during the game, the name of the material of the voxel object may sometimes be displayed (see FIG. 28). In order to perform such a display, the material data includes information on the name of the material.

The property included in the material data is a property set for the material. The property of the material is a property that the voxel object, on which the material is set, possesses in the game. The specific content of the property of the material, and the number of types of properties are discretionary. For example, at least one of the following pieces of information may be set as properties of a material.
Hardness
Weight
Slipperiness
Damage setting in the case where the player character comes into contact with the voxel object
Temperature
Whether another object can be bonded to the voxel object
Amount of hit points to be regained by the player character when the player character destroys or acquires the voxel object
Amount of in-game currency to be gained by the player character when the player character destroys or acquires a voxel object

In other embodiments, information different from those listed above may be set as information indicating a property of a material.

In the exemplary embodiment, the material data includes, as information that identifies a property of a material, an ID indicating the property (see FIG. 12). Although not shown in FIG. 12, the game system 1 stores, for each property to be prepared, property information in which the property ID is associated with the content of the property (e.g., a value indicating the aforementioned weight or slipperiness). By referring to the property information, the game system 1 can specify the specific content of the property set for the material.

The rendering setting included in the material data is information that indicates setting regarding rendering, such as a texture used for rendering of the voxel object for which the material is set. In the exemplary embodiment, the material data includes, as information on rendering setting, an ID of a texture to be used for rendering the voxel object for which the material is set (see FIG. 12). Although not shown in FIG. 12, the game system 1 stores, for each texture prepared, texture information in which the texture ID is associated with the texture indicated by the texture ID. By referring to the texture information, the game system 1 can specify the specific content of the texture set for the material. In other embodiments, as information on rendering setting, any information regarding setting of shading may be set in addition to the texture information. For example, information regarding reflectivity, normal, or the like may be set.

The material data may include data other than the data shown in FIG. 13. For example, the material data may include data regarding sound setting. For example, the data regarding the sound setting may be data that defines the sound of footsteps that is outputted when the player character walks on the voxel object based on the voxel.

The material data may be data of any form capable of specifying the property and/or rendering setting of the material. For example, in other embodiments, the material data may have a data structure including data that directly indicates the property and/or rendering setting of the material, instead of the data structure including the material ID and the texture ID.

### 2-2. Update of Voxel Data

During the game, the voxel object is deformed when the voxel data is updated. In the exemplary embodiment, when a game event for updating the voxel object (hereinafter referred to as “update event”) has occurred, the game system 1 updates the voxel data. The update event may have any content. For example, the update event may be that a character that appears in the game has performed an action to deform the voxel object (e.g., the player character has punched the voxel object), or may be that an event that deforms the voxel object has occurred (e.g., contact of an object thrown by a character with the voxel object, or explosion of a bomb).

FIG. 13 shows an example of a game space when an update event has occurred. In the situation shown in FIG. 13, a player character 201 has performed a punching action to a terrain object 202 that is a voxel object. As will be described in detail below, in the example shown in FIG. 13, the voxel data is updated such that the terrain object 202 at and around a position hit by the punching action of the player character 201 is deleted. This represents how the terrain object 202 is destroyed by the punching action of the player character 201.

In the exemplary embodiment, when such an update event has occurred, the game system 1 sets, in the game space, an update range in which the voxel object is updated (in the example shown in FIG. 13, an update range 203). The position, shape, and size of the update range are discretionary. The position of the update range may be determined based on, for example, a position at which an object regarding the generated update event (e.g., the player character that has punched) comes into contact with the voxel object. In the example shown in FIG. 13, the position of the update range 203 may be determined based on a position that is hit by the punch of the player character 201. For example, the hit position, or a position a predetermined distance ahead of the hit position may be a center position of the update range 203. The shape and size of the update range may be determined in advance according to the type of the update event. For example, when an update event due to a punch of the player character 201 has occurred, the shape and size of the update range may be determined to be a sphere having a predetermined size as shown in FIG. 13. The size of the update range may be determined based on a value indicating the degree of influence of the generated update event (e.g., the intensity of the punch, or the magnitude of the explosion).

The game system 1 changes the density of a voxel corresponding to the set update range. The voxel corresponding to the update range is, for example, a voxel within the update range or a voxel overlapping the update range. As a result of the change in the density, the mesh of the voxel object is changed by a process described below, thereby changing the shape of the voxel object (the shape by appearance, and the shape used for contact determination). In other embodiments, in addition to changing the density of the voxel included in the update range, the game system 1 may change the material in the voxel (e.g., the first material, the second material, and the material mixing ratio), or may change the state in the voxel.

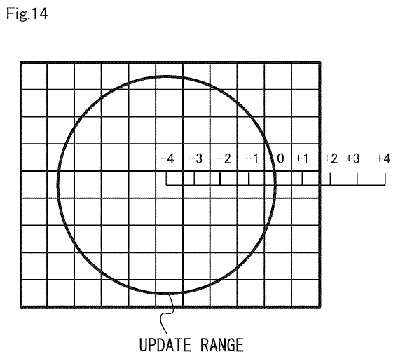

In the exemplary embodiment, the game system 1 determines whether or not a voxel is included in the update range, by using an SDF (Signed Distance Field). The game system 1 sets an SDF indicating an update range set in the game space, and performs the aforementioned determination based on the value of the SDF. The SDF represents distances, with signs, of any positions from a shape that the SDF defines. FIG. 14 shows an example of the update range. In the example shown in FIG. 14, a spherical update range is set in the game space. For example, in the example shown in FIG. 14, an SDF is set such that, among positions in the game space, positions inside the shape represented by the SDF have negative SDF values, and positions outside the shape represented by the SDF have positive SDF values. In this example, whether or not each position is included in the update range can be determined depending on whether or not the SDF value is positive or negative. In addition, using the SDF values allows not only simple inside/outside determination but also a process such as correction or interpolation.

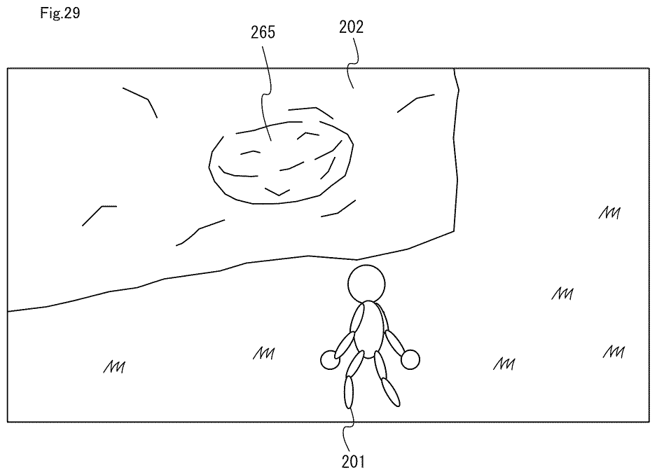

In the example described above, a change in which the voxel object in the update range is deformed as if it is deleted, is applied to the voxel object. However, a change to be applied to the voxel object by using the update range is not limited thereto. For example, a change in which a voxel object is newly added in the update range (e.g., the volume that an area in the voxel object occupies is increased by the update range) may be applied to the voxel object (see FIG. 29 described below). A change in which only the voxel material in the update range is changed while the voxel density is not changed, may be applied to the voxel object. A change in the voxel density and a change in the voxel material may be integrally applied.

### 2-3. Calculation of Vertices

When the voxel density has been updated as described above, the game system 1 sets vertices based on the updated voxel data. The vertices can be vertices of a mesh of a voxel object. As will be described in detail below, in the exemplary embodiment, the vertices are simplified, and the simplified vertices become the vertices of the mesh of the voxel object.

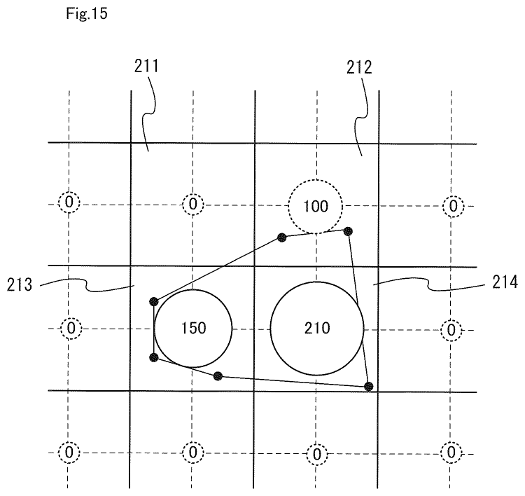

FIG. 15 shows an example of a method for setting vertices. In FIGS. 15 to 24, voxels, vertices, meshes, etc., are represented in two dimensions for the purpose of making the drawings easily viewable, and the description easily understandable. However, in actuality, vertices and meshes are set in a three-dimensional space, based on voxels in the three-dimensional space. In the exemplary embodiment, the game system 1 executes a method in which, for a portion where a voxel having a density that is set to a value indicating “existence” (e.g., a density equal to or greater than a reference value described below) is adjacent to a voxel having a density that is set to a value indicating “nonexistence” (e.g., a density less than the reference value described below), a vertex is set at coordinates based on the positions and densities of a plurality of neighboring voxels around the portion. Hereinafter, this method will be described in detail.

As described above, in the exemplary embodiment, the density set for a voxel is in the range of 0 to 255. A voxel having a density of 0 is completely empty, and a voxel having a density of 255 is completely filled up. Densities between 0 and 255 are complementarily treated, and are used for determining a vertex. In the exemplary embodiment, voxels are virtually treated such that voxels whose densities are equal to or greater than a reference value are inside a voxel object, and voxels whose densities are less than the reference value are outside the voxel object. It is also possible to virtually treat voxels such that voxels whose densities are equal to or greater than the reference value are voxels indicating “existence”, and voxels whose densities are less than the reference value are voxels indicating “nonexistence”. It is not necessary to define only voxels having a density of 0 as being outside the voxel object (e.g., reference value=1), and the reference value may be set to, for example, 128. In the example shown in FIG. 15, a voxel 211 and the other outer voxels have a density of 0, a voxel 212 has a density of 100 which is less than the reference value (e.g., 128), and voxels 213, 214 respectively have densities of 150, 210 which are greater than the reference value. In the exemplary embodiment, the game system 1 generates vertices between the voxels whose densities are equal to or greater than the reference value and the voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. The coordinates of each vertex are determined by comparing the densities of adjacent voxels and performing interpolation based on the difference in density for each of the XYZ axes. Normal information that defines positions and directions of straight lines connecting the vertices may be set in advance, whereby the coordinates of each vertex can be calculated based on the normal information. The normal information may be stored in advance for at least some of the voxels, or if not stored, the normal information may also be calculated based on the densities between adjacent voxels. In FIG. 15, since the density of the voxel 212 is less than the reference value, the voxel 212 is treated as being outside the voxel object in the determination of presence/absence of a vertex, but the density value itself of the voxel 212 is used to calculate the coordinates of the vertices to be generated. If the reference value is set to a value lower than the density of the voxel 212, it would result in an increase in the vertices on the upper right side and the upper left side in the voxel 212 shown in FIG. 15.

By setting the vertices as described above, it is possible to generate a shape whose volume is based on (e.g., reflects) the density of each voxel to some extent, in generating a mesh connecting the set vertices (or vertices obtained by subjecting the set vertices to a simplification process described below). However, depending on the relationship with the neighboring voxels, a voxel having a density of 0 may partially include a region inside the voxel object, or a voxel having a density of 255 may partially include a region outside the voxel object. In the exemplary embodiment, since voxels having densities less than the reference value are treated as being outside the voxel object, there are fewer vertices as compared with a case where those voxels are treated as being inside the voxel object, and the volume will be smaller accordingly. That is, there is no need to calculate the polygon mesh so that the volume strictly corresponds to the density value.

### 2-4. Determination of Material of Vertex

The game system 1 determines a material for each of the vertices set as described above. The material of the vertex is determined based on materials regarding voxels around this vertex. The voxels around the vertex are, for example, voxels used for determining whether or not to generate the vertex (e.g., voxels overlapping the aforementioned region that straddles voxels). In other embodiments, the voxels used for determining the material of the vertex and the voxels used for determining generation of the vertex may not necessarily be the same, and may be different from each other.

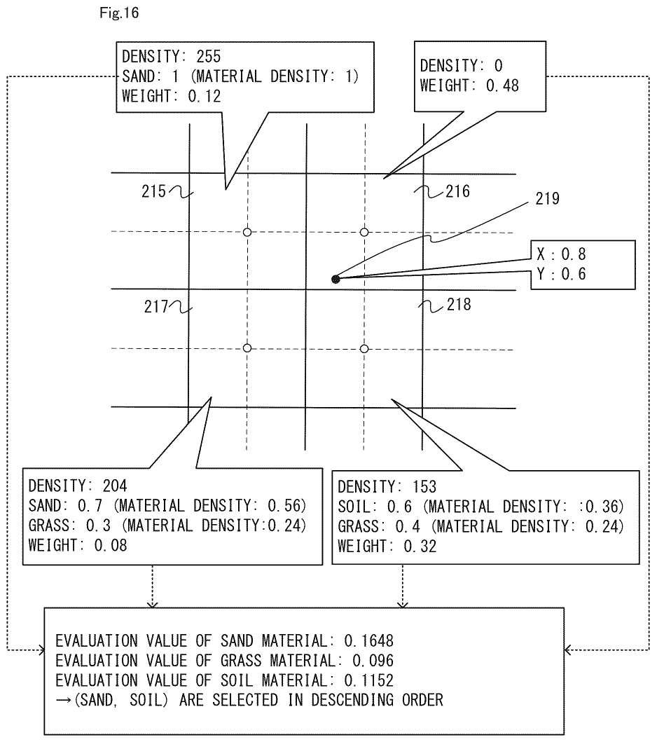

FIG. 16 shows an example of a method for determining a material of a vertex. In the example shown in FIG. 16, a vertex 219 is set with respect to four voxels 215 to 218, and the four voxels 215 to 218 correspond to the aforementioned “voxels around the vertex”. In an actual three-dimensional space, the number of voxels around the vertex is eight. In the example shown in FIG. 16, as for the voxel 215, a density of 255, a first material of “sand”, and a material mixing ratio of 0 (e.g., first material:second material=1:0, or the second material may not necessarily be set) are set. As for the voxel 216, a density of 0 is set (the first and second materials may not necessarily be set). As for the voxel 217, a density of 204, a first material of “sand”, a second material of “grass”, and a material mixing ratio of 0.3 (e.g., first material:second material=0.7:0.3) are set. As for the voxel 218, a density of 153, a first material of “soil”, a second material of “grass”, and a material mixing ratio of 0.4 (e.g., first material:second material=0.6:0.4) are set. In addition, the coordinates indicating the position of the vertex 219 are (X, Y)=(0.8, 0.6). A coordinate system for the coordinates has an X coordinate in the left-right direction and a Y coordinate in the up-down direction, in FIG. 16. In the coordinate system, among center positions of the voxels 215 to 218 (positions of white circles in FIG. 16), the center position of the lower-left voxel 217 is (0, 0).

In determining a material of the vertex, the game system 1 calculates an evaluation value for each of the materials of the neighboring voxels, based on the density of the material, and a weight value based on the distance from the voxel to the vertex. First, the weight value is calculated for each voxel. The shorter the distance from the center position of the voxel to the vertex is, the greater the weight value is. In the exemplary embodiment, assuming that the center position of a certain voxel is (x1, y1) and the coordinates of the vertex are (x2, y2), a weight value for the voxel is calculated according to the following formula (1).

$$( weight value ) = \vert ( 1 - x 1 ) - x 2 \vert \cdot \vert ( 1 - y 1 ) - y 2 \vert \qquad ( 1 )$$

In the example shown in FIG. 16, the weight values of the voxels 215 to 218 calculated according to the formula (1) are as follows.

$$( weight value of voxel 215 ) = \vert ( 1 - 0 ) - 0.8 \vert \cdot \vert ( 1 - 1 ) - 0.6 \vert = 0.12$$

$$( weight value of voxel 216 ) = \vert ( 1 - 1 ) - 0.8 \vert \cdot \vert ( 1 - 1 ) - 0.6 \vert = 0.48$$

$$( weight value of voxel 217 ) = \vert ( 1 - 0 ) - 0.8 \vert \cdot \vert ( 1 - 0 ) - 0.6 \vert = 0.08$$

$$( weight value of voxel 218 ) = \vert ( 1 - 1 ) - 0.8 \vert \cdot \vert ( 1 - 0 ) - 0.6 \vert = 0.32$$

The game system 1 calculates a density of a material for each voxel. Here, the density of the material is a value obtained by multiplying the proportion of this material, among materials set for the voxel, by the density of the voxel. In the exemplary embodiment, for the densities of the voxels, values obtained by normalizing the aforementioned values from 0 to 255 to values from 0 to 1 are used. In the example shown in FIG. 16, as for the voxel 215, since the material set for this voxel is only sand, the proportion regarding the sand material is 1, and the density of the voxel is 1, and therefore, the density of the sand material is 1. As for the voxel 216, since the density is 0 and no material is set, a material density is not calculated. If any material is set, the density of this material is 0. As for the voxel 217, the proportions of the sand material and the grass material being set are 0.7 and 0.3, respectively, and the density of the voxel is 204/255=0.8. Therefore, the density of the sand material is 0.7·0.8=0.56, and the density of the grass material is 0.3·0.8=0.24. As for the voxel 218, the proportions of the soil material and the grass material being set are 0.6 and 0.4, respectively, and the density of the voxel is 153/255=0.6. Therefore, the density of the soil material is 0.6·0.6=0.36, and the density of the grass material is 0.4·0.6=0.24.

Then, the game system 1 calculates the evaluation value for each material, based on the weight value and the density of the material. In the exemplary embodiment, the evaluation value of the material is a value obtained by weighting the density of the material calculated for each voxel, according to the weight value of the voxel, and summing up the weighted densities of the neighboring voxels. In the example shown in FIG. 16, the evaluation value of the sand material is 1·0.12+0.56·0.08=0.1648 because the density of the material is 1 and the weight value is 0.12 for the voxel 215, and the density of the material is 0.56 and the weight value is 0.08 for the voxel 217. The evaluation value of the grass material is 0.24·0.08+0.24·0.32=0.096 because the density of the material is 0.24 and the weight value is 0.08 for the voxel 217, and the density of the material is 0.24 and the weight value is 0.32 for the voxel 218. The evaluation value of the soil material is 0.36·0.32=0.1152 because the density of the material is 0.36 and the weight value is 0.32 for the voxel 218.

The game system 1 determines a material of the vertex, based on the evaluation values of the respective materials. Specifically, a predetermined number of materials in order from one having the greater evaluation value are determined as materials of the vertex. In the exemplary embodiment, two materials having the first and second greatest evaluation values are determined as materials of the vertex. In the example shown in FIG. 16, since the evaluation values of the sand, grass, and soil materials are 0.1648, 0.096, and 0.1152, respectively, the sand material and the soil material are determined as the materials of the vertex. Furthermore, the game system 1 calculates the ratio of the determined two materials, based on the evaluation values described above. In the exemplary embodiment, the ratio of the two materials may be represented as a second material ratio that is a ratio of the second material to the whole, like the aforementioned material mixing ratio. In the example shown in FIG. 16, for example, if the first material and the second material are set to soil and sand, respectively, the second material ratio is represented as 0.1648/(0.1648+0.1152)≈0.59. In other embodiments, as a value representing the ratio of the two materials, a value representing the proportion of the first material may be used. Alternatively, values representing the proportions of the respective materials may be used.

In the exemplary embodiment, the game system 1 generates and stores therein vertex data indicating the position of a vertex, material IDs of the first and second materials set for the vertex, and the ratio of the materials. However, the method for managing materials set for a vertex is discretionary. In other embodiments, the vertex data may have a data structure including data that directly indicates the contents of the first and second materials.

As described above, in the exemplary embodiment, regarding material IDs included in voxel data of a plurality of neighboring voxels around each vertex, the game system 1 calculates a priority parameter (e.g., evaluation value) for each material ID, based on the voxel data. Then, based on the priority parameters, the game system 1 selects a predetermined number of (two in this embodiment) material IDs having the higher priorities, and determines the selected materials IDs as material IDs for the vertex. The specific parameter to be used as the priority parameter is not limited to the evaluation value. For example, in other embodiments, an evaluation value that is calculated using the density of the material without using the weight value may be used as a priority parameter.

In the exemplary embodiment, the evaluation value as an example of the priority parameter is calculated based on the densities of the plurality of neighboring voxels around the vertex such that the material set for the voxel having the higher density has the higher priority (e.g., the evaluation value of the material is increased and thereby the material is highly likely to be selected). Thus, the material of the vertex can be determined while also incorporating (e.g., reflecting) the magnitude of the density set for the voxel.

In the exemplary embodiment, the evaluation value as an example of the priority parameter is calculated based on the distances from reference positions (specifically, center positions) of a plurality of neighboring voxels around the vertex, to the vertex such that the material set for the voxel closer to the vertex has the higher priority. Thus, the material of the vertex can be determined while also incorporating (e.g., reflecting) the distances between the voxels and the vertex.

In the exemplary embodiment, it can also be said that the evaluation value as an example of the priority parameter is calculated based on the material mixing ratios of a plurality of neighboring voxels around the vertex such that the material having the higher material mixing ratio has the higher priority. Thus, in the case where a plurality of materials are set for one voxel, the material of the vertex can be determined while also incorporating (e.g., reflecting) the ratio of the materials.

### 2-5. Simplification of Vertices

In the exemplary embodiment, the game system 1 simplifies the vertices calculated as described above. That is, the game system 1 replaces some of the vertices calculated as described above with one vertex to decrease the number of vertices. As will be described in detail below, the coordinates (e.g., position) and the material of the replacing vertex are set based on a plurality of vertices before replacement. Such simplification can reduce the numbers of vertices and polygons that form a mesh of a voxel object, thereby reducing the amount of memory used for processing, and reducing the processing load.

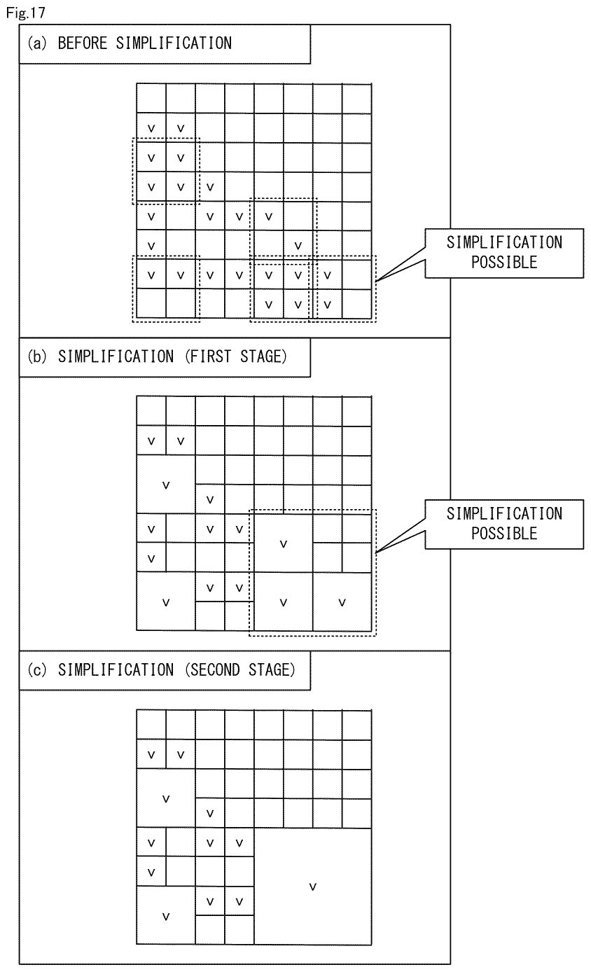

In the exemplary embodiment, the game system 1 performs simplification by representing vertices using SVO (Sparse Voxel Octree). FIG. 17 shows an example of vertex simplification. In FIG. 17, one square delimited by solid lines in (a) represents one vertex division region. Here, the vertex division region is a square region with a center position of a voxel being a vertex (in an actual three-dimensional space, the vertex division region is a cube or a rectangular parallelepiped), and corresponds to a region with the dotted lines being sides shown in FIG. 15 and FIG. 16. In FIG. 17, each vertex division region having a character “v” inside is a vertex division region in which a vertex is set.

In the exemplary embodiment, the game system 1 determines whether or not simplification can be performed with respect to the vertices in a predetermined number of (four in FIG. 17, and eight in an actual three-dimensional space) vertex division regions adjacent to each other. If the determination result is that simplification can be performed, simplification is performed for the vertices in the predetermined number of vertex division regions.

In FIG. 17, (a) shows the state before simplification is performed. In the example shown in FIG. 17, it is determined that simplification can be performed for vertex division regions within a range surrounded by dotted lines. In this case, the game system 1 performs simplification such that the vertices in the predetermined number of vertex division regions determined to be simplified are replaced with one vertex (see (b) of FIG. 17). Thus, the vertices in the predetermined number of vertex division regions are simplified to one vertex.

In the exemplary embodiment, the game system 1 performs simplification in a plurality of stages. The number of the stages is discretionary. In FIG. 17, first and second stages are shown and described. In FIG. 17, (b) shows the state in which the first-stage simplification has been performed, and (c) shows the state in which the second-stage simplification has been performed. In the second-stage simplification, whether or not simplification can be performed is determined for vertices that are generated by the first-stage simplification. In the example shown in FIG. 17, when the determination result is that the vertex division regions within a range surrounded by dotted lines in (b) of FIG. 17 can be subjected to simplification, the vertices in the vertex division regions are simplified, resulting in the state shown in (c) of FIG. 17. The condition for determining whether or not the first-stage simplification can be performed and the condition for determining whether or not the second-stage simplification can be performed may be the same or different from each other.

The specific method for determining whether or not simplification can be performed is discretionary. In the exemplary embodiment, as conditions for the above determination, a condition regarding the shape of the voxel object and a condition regarding the material of the voxel object are used. In the exemplary embodiment, if both the condition regarding the shape of the voxel object and the condition regarding the material of the voxel object are satisfied, it is determined that simplification can be performed. If at least one of the condition regarding the shape of the voxel object and the condition regarding the material of the voxel object is not satisfied, it is determined that simplification cannot be performed.

The condition regarding the shape is, for example, that there is no significant change between the shape due to the vertices before the simplification and the shape due to the vertices after the simplification. For example, determination as to whether or not there is a significant change in the shape due to the vertices before and after the simplification may be performed by calculating an index indicating an error between the mesh before the simplification and the mesh after the simplification, and determining whether or not the index is equal to or smaller than a predetermined allowable value. Furthermore, for example, if the shape due to the vertices after the simplification is not a hollow shape while the shape due to the vertices before the simplification is a hollow shape (e.g., the simplification causes missing of information that the shape is hollow), it is determined that the condition regarding the shape is not satisfied. Whether or not the aforementioned case will occur can be determined based on, for example, the densities of voxels corresponding to the vertex division regions to be subjected to the determination. Moreover, for example, if the shape due to the vertices before the simplification can be represented only by two or more vertices, e.g. it cannot be represented by one vertex, it is determined that the condition regarding the shape is not satisfied. As the condition regarding the shape of the voxel object, the same condition as that used for the conventional method with the SVO may be used.

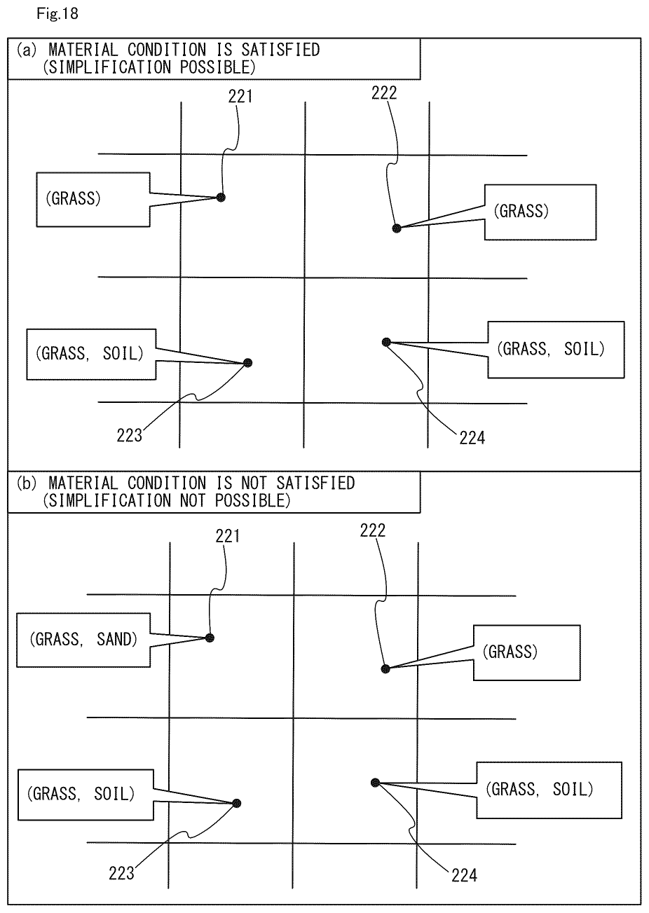

In the exemplary embodiment, as the condition regarding the material, a condition regarding the number of types of materials to be set for the vertices in the predetermined number of vertex division regions to be subjected to simplification, is used. FIG. 18 shows an example of the first condition regarding the material. In FIG. 18, (a) shows a case where the materials of vertices 221 to 224 are “grass”, “grass”, “grass and soil”, and “grass and soil”, respectively, and (b) shows a case where the materials of the vertices 221 to 224 are “grass and sand”, “grass”, “grass and soil”, and “grass and soil”, respectively. In the exemplary embodiment, the condition regarding the material is that the total number of the types of materials set for the vertices to be subjected to simplification is equal to or less than a predetermined number. For example, the condition regarding the material is that the total number is equal to or less than the number of materials that can be set for one vertex. In the exemplary embodiment, the predetermined number is 2. For example, in the case of (a) of FIG. 18, since the total number of the types of materials set for the vertices 221 to 224 to be subjected to simplification is 2 (e.g., grass and soil), the condition regarding the material is satisfied. In this case, it is determined that the vertices 221 to 224 can be subjected to simplification on the condition that the aforementioned condition regarding the shape of the object are satisfied. On the other hand, in the case of (b) of FIG. 18, since the total number of the types of materials set for the vertices 221 to 224 to be subjected to simplification is 3 (e.g., grass, soil, and sand), the condition regarding the material is not satisfied. In this case, it is determined that the vertices 221 to 224 cannot be subjected to simplification regardless of whether or not the second condition and the condition regarding the shape of the object are satisfied.

In the game system 1, multiple types of materials to which the same property is set and which are different in appearance may be prepared even though these materials should strictly be classified into different types. Some of the multiple types of materials may be regarded as being of the same type in determining whether the condition regarding the material is satisfied. For example, multiple types of soil materials having the same property and similar appearances (e.g., texture colors or patterns) may be prepared. In this case, the game system 1 may determine whether the condition regarding the material is satisfied while regarding the multiple types of soils as being of the same type.

In the exemplary embodiment, at most two types of materials can be set for a vertex as in the case of a voxel. Meanwhile, in the exemplary embodiment, if the total number of the types of materials set for the vertices to be subjected to simplification is three or more, simplification is not performed. That is, if the total number of the types of materials exceeds the number of materials that can be set for one vertex, simplification is not performed. Therefore, even when the number of vertices is reduced through simplification, the simplification does not cause missing of information on the materials set for the vertices, thereby maintaining the information on the materials.

In the exemplary embodiment, a material of the vertex after the simplification is determined based on the materials of the vertices before the simplification. Specifically, the game system 1 sets the one or two types of materials set on the vertices before the simplification, as the first material and the second material of the vertex after the simplification. This allows the information on the materials to be maintained. The ratio of the materials after the simplification is determined based on the ratio of the materials of the vertices before the simplification. In the exemplary embodiment, the radio of the materials after the simplification is calculated similarly to the aforementioned method for calculating the ratio of materials of vertices by using the evaluation values. That is, the game system 1 calculates weight values based on the distances between the vertex after the simplification and the vertices before the simplification, and calculates an evaluation value for each material, based on the weight values and the densities of the materials of the vertices before the simplification (the evaluation values of the materials described in the above [2-4. Determination of material of vertex] can be used as the densities of the materials here). Then, the ratio of the materials is calculated based on the calculated evaluation values of the materials.

### 2-6. Generation of Mesh

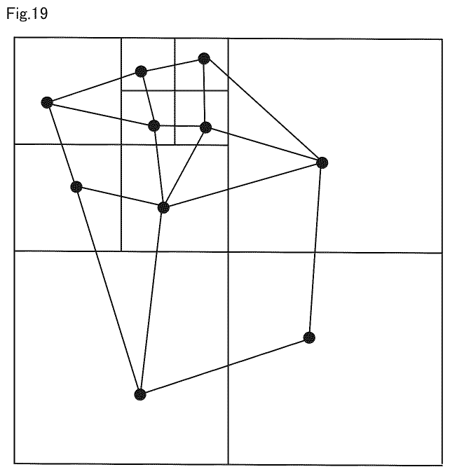

In the exemplary embodiment, a mesh of a voxel object is generated based on vertices having been simplified as described above. FIG. 19 shows an example of a mesh generated based on such vertices. Each of squares shown in FIG. 19 represents a vertex division region as described above, or a vertex division region obtained by integrating a plurality of vertex division regions through simplification. As shown in FIG. 19, the game system 1 generates a mesh that is composed of polygonal shapes each having, as one side, a straight line connecting vertices of adjacent vertex division regions. Each of the polygonal shapes forming the mesh is a triangle or a quadrangle.

In the exemplary embodiment, the game system 1 generates two types of meshes, a display mesh and a determination mesh. The display mesh is a mesh used for displaying a voxel object. The determination mesh is a mesh used for collision determination for a voxel object. As will be described in detail below, by using the two types of meshes, the game system 1 can perform processing with the meshes suitable for display of the voxel object and collision determination, respectively.

In the exemplary embodiment, the game system 1 generates the display mesh and the determination mesh, based on data of the SVO described above (e.g., based on the simplified vertices). Thus, sharing vertex data in generating the two types of meshes improves efficiency of processing. In other embodiments, the game system 1 may not necessarily perform simplification of vertices, and may generate a display mesh and/or a determination mesh, based on vertices that are not simplified.

In the exemplary embodiment, the game system 1 generates the determination mesh so as to be simpler in shape than the display mesh. Specifically, the game system 1 makes the number of vertices of the determination mesh less than the number of vertices of the display mesh. Here, in the exemplary embodiment, the data of the SVO holds, in an octree data structure, data of vertices before simplification and data of simplified vertices, and also includes data used for determining whether or not simplification can be performed. This data includes, for example, data of vertices (referred to as “provisional vertices”) calculated as candidates for a vertex after simplification, and data of the aforementioned index indicating an error between the vertices before simplification and the provisional vertices. For example, the game system 1 may use, among the provisional vertices, a vertex the index of which is equal to or less than a predetermined threshold value (this threshold value is greater than the aforementioned allowable value), for generation of the determination mesh. This allows the number of vertices of the determination mesh to be less than the number of vertices of the display mesh. The number of vertices of the determination mesh being less than the number of vertices of the display mesh allows a reduction in processing load for collision determination. Moreover, since the number of vertices of the display mesh is not excessively reduced, the appearance of the voxel object can be represented in detail.

In other embodiments, the display mesh and the determination mesh may be generated based on the same data, or may be generated based on different data. The display mesh and the determination mesh may have the same shape (even in this case, materials set for these meshes may be different from each other). The number of vertices of the determination mesh may be equal to the number of vertices of the display mesh, or may be greater than the number of vertices of the display mesh.

### 2-6-1. Determination of Material of Display Mesh

Next, an example of a method for determining materials and an appearance of a display mesh will be described. In the exemplary embodiment, the game system 1 determines a material for each of the polygonal shapes forming the display mesh. As will be described in detail below, in the exemplary embodiment, a polygon corresponding to each polygonal shape is rendered using at most two types of textures corresponding to at most two types of materials. Therefore, the game system 1 determines materials for the polygonal shapes forming the mesh such that two or less types of materials are finally set for one polygonal shape. In other embodiments, three or more materials may be set. For example, in an embodiment in which three or more types of voxel materials and three or more types of vertex materials are set, the same number of materials may be set for the polygonal shapes.

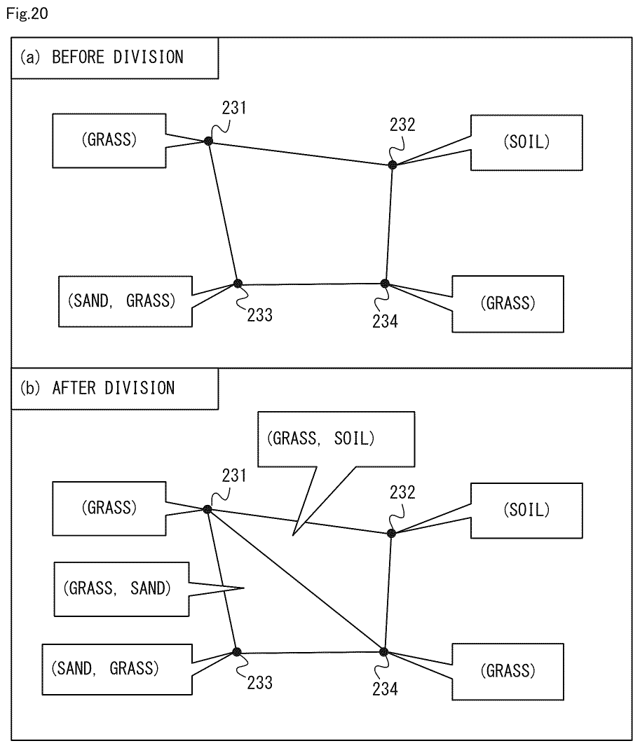

In the exemplary embodiment, quadrangles may be formed as polygonal shapes forming the display mesh (see FIG. 19). In determining materials of the display mesh, the game system 1 firstly divides each of the quadrangles forming the display mesh into two triangles under certain conditions. Hereinafter, a process of dividing a quadrangle into two triangles will be described with reference to FIG. 20.

FIG. 20 shows an example of diving a quadrangle forming a mesh into two triangles. In FIG. 20, (a) shows a quadrangle before division, formed by vertices 231 to 234 included in the vertices of the mesh. In FIG. 20, (b) shows two triangles into which the quadrangle is divided. In the example shown in FIG. 20, “grass”, “soil”, “sand and grass”, and “grass” are set as materials of the respective vertices 231 to 234.

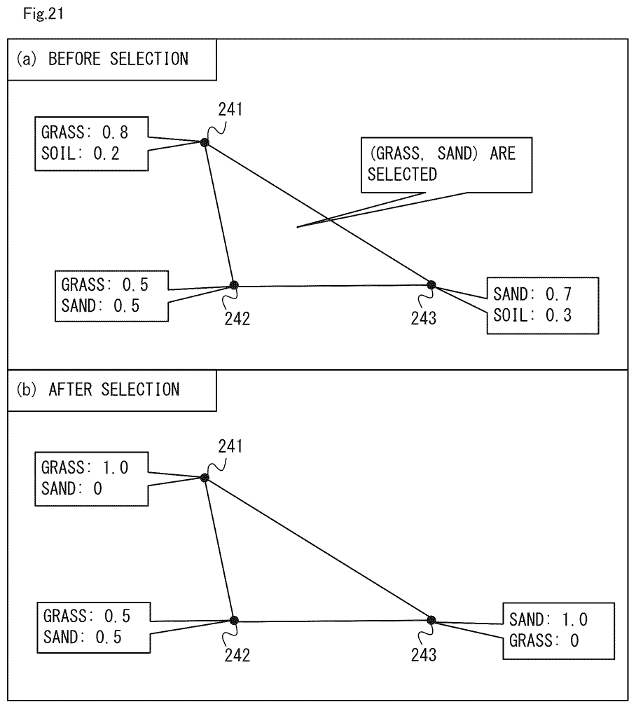

In the exemplary embodiment, if the number of types of materials set for the vertices of the quadrangle is three or more in total, the game system 1 determines whether or not a division condition is satisfied. In the exemplary embodiment, the division condition is that dividing the quadrangle into two triangles allows the number of types of materials set for the vertices of each triangle to be two or less in total. If the division condition is satisfied, the game system 1 divides the quadrangle into two triangles each having two or less types of materials set for the vertices. In the example shown in FIG. 21, three types of example materials, grass, soil, and sand, are set for the vertices 231 to 234 forming the quadrangle. If the quadrangle is divided into a triangle formed by the vertices 231, 232, 234 and a triangle formed by the vertices 231, 233, 234, two types of materials, sand and grass, are set for the vertices of the former triangle, and two types of materials, grass and soil, are set for the vertices of the latter triangle (see (b) of FIG. 20). Since the division condition is satisfied for the quadrangle, the game system 1 divides the quadrangle into two triangles.

Since there are two methods for dividing a quadrangle into two triangles, if the division condition is satisfied for the triangles into which the quadrangle is divided by at least one of the two methods, the game system 1 performs the division by the method satisfying the division condition. Meanwhile, if the division condition is not satisfied for the triangles into which the quadrangle is divided by either of the two methods, the game system 1 performs the division by either method.

By performing the division as described above, the game system 1 can generate two triangles each having two or less types of materials set for the vertices, without missing information on three or more types of materials set for the vertices of the quadrangle as much as possible. Here, as described above, each of the polygons forming the mesh is rendered using at most two types of textures. Therefore, by performing the division, the game system 1 can render each polygon by using two types of textures without missing information on the materials set for the vertices as much as possible.

In the exemplary embodiment, the game system 1 sets polygons corresponding to the polygonal shapes obtained through the aforementioned division. That is, the vertices of the polygonal shapes obtained through the division become the vertices of the polygons of the display mesh.

In the exemplary embodiment, as for the polygons forming the display mesh, if the number of types of materials set for the vertices of one polygon is three or more in total, the game system 1 selects two types of materials to determine materials of this polygon. FIG. 21 shows an example of a method for determining materials of a polygon forming the display mesh. In the example shown in FIG. 21, as for a vertex 241 of a triangular polygon forming the display mesh, the first material is “grass”, the second material is “soil”, and the material ratio of the first material to the second material is 0.8:0.2. As for a vertex 242 of the polygon, the first material is “grass”, the second material is “sand”, and the material ratio of the first material to the second material is 0.5:0.5. As for a vertex 243 of the polygon, the first material is “sand”, the second material is “soil”, and the material ratio of the first material to the second material is 0.7:0.3.

If the number of types of materials set for the vertices of the polygon is three or more in total, the game system 1 calculates a determination value for each material. The determination value is calculated as a sum of the proportions of the material at the vertices on which the material is set. Then, the game system 1 selects two materials in order from one having the greatest determination value, as materials of the polygon. In the example shown in FIG. 21, the determination value of the grass material is 0.8+0.5=1.3, the determination value of the sand material is 0.5+0.7=1.2, and the determination value of the soil material is 0.2+0.3=0.5. Therefore, the grass material and the sand material are selected as materials of the polygon shown in FIG. 21 (see (a) of FIG. 21).

The specific method for selecting a material of a polygon of the display mesh is discretionary. In other embodiments, a material of a polygon of the display mesh may be selected by any method based on information set for the vertices of the polygon. For example, a material of a polygon of the display mesh may be selected as follows. That is, a material having the greatest proportion at one vertex is specified for each vertex, and a material that is most frequently specified for each vertex is selected as a material of the polygon.

In the exemplary embodiment, the selected materials of the polygon are indicated as materials set for the vertices of the polygon. That is, when the materials of the polygon have been selected, the game system 1 changes the materials being set for the vertices of the polygon (e.g., the material IDs included in the vertex data) to the selected materials. In the example shown in FIG. 21, as for the vertex 241 and the vertex 243, “grass and soil” and “sand and soil” are respectively set before the selection of materials of the polygon (see (a) of FIG. 21). When grass and sand have been selected as materials of the polygon as described above, the materials set for the vertex 241 and the vertex 243 are changed to “grass and sand” (see (b) of FIG. 21). Since the materials set for the vertex 242 before the selection are the same as the selected materials of the polygon, the materials are not changed. In the case where two types of materials are selected as materials of the polygon as described above, information on the third and subsequent types of materials set for the vertices of the polygon are deleted.

According to the change of the materials set for each vertex, the game system 1 changes the ratio of the materials set for the vertex. For example, as for the vertex 241, the content indicating that the first material is grass and the second material is soil is changed to the content indicating that the first material is grass and the second material is sand. Here, since the proportion of the sand material is 0, the material ratio of the first material to the second material becomes 1:0. Thus, the above change is formally changing the materials of the vertices of the polygon in order to represent the materials of the polygon by the materials of the vertices of the polygon.

According to the above, since the materials set for the vertices of one polygon are only the materials corresponding to the textures used for rendering described below, a rendering process using the textures can be easily performed.

There may be a case where the aforementioned change causes all the materials at a certain vertex to be changed (e.g., none of the materials after the change correspond to the materials before the change). For example, there is a case where the material set for the vertex before the change is soil, and the materials selected as materials of the polygon are grass and sand. In this case, the ratio of the materials at the certain vertex may be set based on the material ratios at the other vertices of the polygon. For example, in the above example, in the case where the first material set for one of the remaining two vertices of a triangular polygon is grass and the material ratio of grass to sand is 1:0 while the material set for the other vertex is sand and the material ratio of sand to grass is 1:0, the material ratio at the certain vertex may be set to grass:sand=0.5:0.5. The game system 1 may determine the material ratio at the certain vertex in consideration of the distance between this vertex and the other vertex (e.g., based on a weight value that increases as the distance is shorter).

As described above, in the exemplary embodiment, the game system 1 selects, for each polygon, at most a predetermined number of (two in this embodiment) material IDs from among the material IDs set for the vertices included in the polygon (e.g., material IDs set for the vertices of the polygonal shape corresponding to the polygon), and determines the selected material IDs as material IDs of the polygon. Thus, the game system 1 can perform the rendering process with the number of textures to be used being reduced, while incorporating (e.g., reflecting) the materials set for the vertices into the appearance of the polygon.

In the exemplary embodiment, regarding the materials of all the vertices forming a polygon, if the number of the materials is equal to or less than the predetermined number, the game system 1 determines the materials as materials of the polygon. Meanwhile, if the number of the materials exceeds the predetermined number, the game system 1 selects a predetermined number of materials having higher priorities, based on the priority parameters of the vertices (specifically, based on the determination values calculated based on the aforementioned evaluation values), and determines the selected materials as materials of the polygon. Thus, even if the number of the materials set for the vertices exceeds, in total, the predetermined number, the number of the materials of the polygon can be made equal to or less than the predetermined number in consideration of the priority.

As described above, in the exemplary embodiment, the first and second materials set for each of the vertices of one polygon are changed to the two types of materials to be set for the polygon. In performing such a change, as for a vertex shared by adjacent two polygons, there is a possibility of inconsistency in the first and second materials to be set.

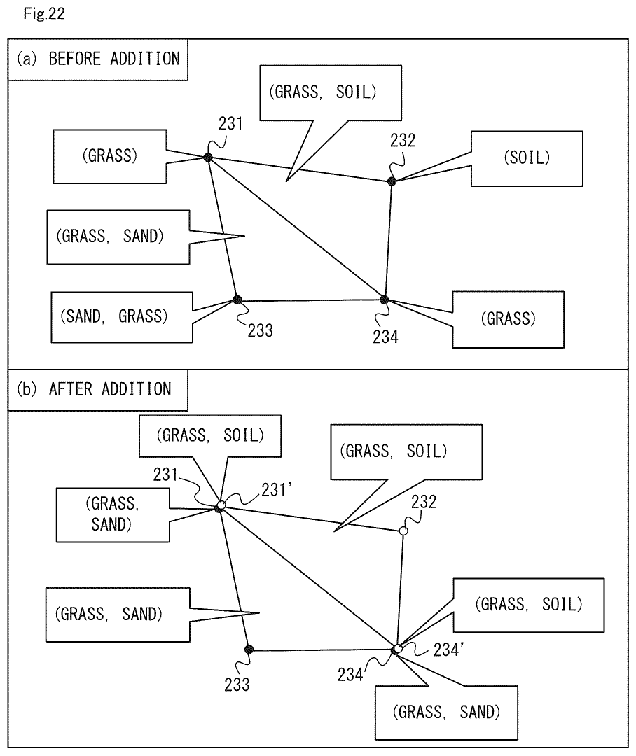

FIG. 22 shows an example of materials set for vertices of adjacent two polygons. FIG. 22 shows a state in which two polygons are formed by the vertices 231 to 234 shown in FIG. 20 ((b) of FIG. 20). In the example shown in FIG. 22, since grass and sand are determined as materials of a first polygon formed by the vertices 231, 233, and 234, the first and second materials of these vertices should be set to grass and sand, respectively. Meanwhile, since grass and soil are determined as materials of a second polygon formed by the vertices 231, 232, and 234, the first and second materials of these vertices should be set to grass and soil, respectively. Therefore, in the example shown in FIG. 22, as for the vertices 231 and 234 shared by the two polygons, inconsistency occurs in the materials to be set.

In the exemplary embodiment, when inconsistency occurs in material to be set for a vertex shared by two polygons, the game system 1 adds another vertex at the position of the vertex. In FIG. 22, (b) shows an example of a state in which a vertex 231′ is added for the vertex 231 and a vertex 234′ is added for the vertex 234. In the example shown in FIG. 22, the game system 1 sets, for the vertices 231 and 234, grass and sand as the first and second materials according to the materials of the first polygon. In addition, the game system 1 sets, for the vertices 231′ and 234′, grass and soil as the first and second materials according to the materials of the second polygon. By formally setting two vertices as vertices to be shared by two polygons (e.g., by generating data of two vertices located at the same position and having different materials), it is possible to inhibit occurrence of inconsistency in materials to be set for the vertices.

The game system 1 generates a display mesh composed of the polygons whose vertices and materials are determined as described above. In addition, the game system 1 renders the polygons, based on information on the materials set for the vertices (e.g., the first material and the second material), thereby rendering a voxel object.

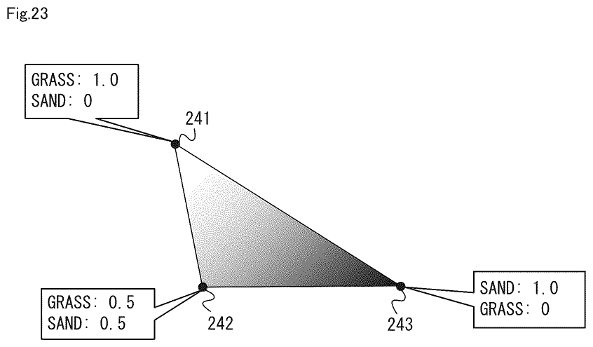

FIG. 23 shows an example of applying a texture to a polygon. FIG. 23 shows a triangular polygon formed by the vertices 241 to 243 shown in FIG. 21. The materials set for the vertices 241 to 243 are those shown in (b) of FIG. 21.

As for the position of a vertex of a polygon, rendering is performed by a mapping in which a texture of a first material set for the vertex and a texture of a second material set for the vertex are blended at a ratio of the materials set for the vertex (e.g., using this ratio as a blending ratio). The textures of the first and second materials used for the rendering are textures indicated by information on rendering setting associated with the material ID that is associated with data of the vertex in the aforementioned material data (see FIG. 12). In the example shown in FIG. 23, as for the position of the vertex 241, since the material ratio of grass to sand is 1:0, rendering is performed by using only the texture of grass. As for the position of the vertex 243, since the first material is sand and the material ratio of sand to grass is 1:0, rendering is performed by using only the texture of sand. As for the position of the vertex 242, since the first material is grass, the second material is sand, and the material ratio of grass to sand is 0.5:0.5, rendering is performed such that the texture of grass and the texture of sand are blended at a blending ratio of 0.5:0.5.

As for positions other than the vertices of the polygon, the game system 1 determines a blending ratio by interpolating the blending ratios at the vertices. Then, rendering is performed by a mapping in which the textures of two materials set for each vertex are blended at the interpolated blending ratio. The specific method for interpolation is discretionary. As an example, a blending ratio between vertices is subjected to linear interpolation. In FIG. 23, a position at which the texture of grass material is applied at a high ratio is shown in white, and a position at which the texture of sand material is applied at a high ratio is shown in black. In the example shown in FIG. 23, the texture of grass is applied to the vertex 241, and the blending ratio of the texture of sand increases toward the vertex 243. At the position of the vertex 242, the blending ratio of grass to sand becomes 1:1, and only the texture of sand is applied at the position of the vertex 243. Thus, rendering is performed with the two textures set for the polygon (e.g., set for the vertices of the polygon) being blended with the blending ratio according to the material ratio, whereby the appearance at the boundary between different materials can be made natural in the display mesh. This makes the appearance of the display mesh, in which a plurality of types of materials are set, natural.

### 2-6-2. Determination of Material of Determination Mesh

Next, an example of a method for determining materials of a determination mesh will be described. As will be described in detail below, in the exemplary embodiment, there may be a case where collision determination is performed for a voxel object by using a determination mesh, and processing is performed according to a material of a voxel object for which a collision has been determined. Therefore, in the exemplary embodiment, materials are determined also for the determination mesh.

In the exemplary embodiment, the game system 1 sets polygons corresponding to the polygonal shapes forming the determination mesh such that one type of material is set for one polygon. Specifically, the game system 1 determines a material to be set for a polygon of the determination mesh, based on information on materials set for vertices of this polygon (e.g., information on first and second materials, and a material ratio).

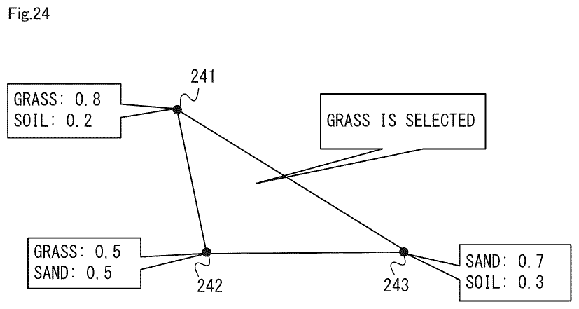

FIG. 24 shows an example of a method for determining a material of a polygon forming the determination mesh. FIG. 24 shows an example of determining a material for a triangular polygon formed by the vertices 241 to 243 shown in FIG. 21. The materials set for the vertices 241 to 243 are those shown in (a) of FIG. 21.

In determining a material of a polygon, the game system 1 calculates a determination value for each of materials set for the vertices of the polygon. In the exemplary embodiment, a calculation method for the determination value is identical to the calculation method for the determination value that is used for selection of the materials to be set for the polygonal shapes of the display mesh. The specific calculation method for the determination value is discretionary. In other embodiments, the determination value may be calculated in any method based on information set for the vertices of the polygon of the determination mesh.

In the example shown in FIG. 24, the determination value for each material is 1.3 for the grass material, 1.2 for the sand material, and 0.5 for the soil material as in the case shown in FIG. 21. Therefore, the grass material is selected as a material of the polygon shown in FIG. 24.

As described above, in the exemplary embodiment, the game system 1 selects, for each polygon, at most a predetermined number of (one in this embodiment) material IDs from among the material IDs set for the vertices included in the polygon (e.g., material IDs set for the vertices of the polygonal shape corresponding to the polygon), and determines the selected material ID as a material ID of the polygon. This allows the game system 1 to reduce the number of materials to be set for the determination mesh to the predetermined number or less. Thus, processing based on the material type, which is performed according to the result of collision determination using the determination mesh, is prevented from being complicated. The method for determining a material of a polygon of the determination mesh is discretionary, and is not limited to the above method. In other embodiments, a material of a polygon of the determination mesh may be determined by any method based on information set for the vertices of the polygon.

In the exemplary embodiment, one type of material is set for a polygon of the determination mesh while at most two types of materials are set for a polygon of the display mesh. Therefore, natural appearance can be achieved for the polygon of the display mesh by using two types of textures. In addition, as for the determination mesh, a process to be performed according to the result of collision determination using the determination mesh can be prevented from being complicated. In other embodiments, the types of materials settable for polygons of the display mesh and the determination mesh are discretionary. The number of materials settable for a polygon of the display mesh and the number of materials settable for a polygon of the determination mesh each may be plural, and may be the same or different from each other.

In the exemplary embodiment, the number of types of materials to be set for one voxel is two at most, and the number of types of materials to be set for one polygon in the display mesh is two at most. Thus, information on materials set in the voxel data can be used for (e.g., reflected in) the materials of the display mesh while reducing the data amount of the voxel data. Moreover, in the exemplary embodiment, the number of types of materials to be set for vertices based on the voxel data is also two at most (see FIG. 16). In this case, since two types of materials can be set also for vertices that are generated during the process to obtain the display mesh from the voxel data, the information on materials set in the voxel data used for (e.g., reflected in) the display mesh, without missing the information on materials during the process.

In other embodiments, the game system 1 may set materials such that, regarding vertices to be set based on the voxel data, materials set for vertices to be used for generation of the display mesh are different from materials set for vertices to be used for generation of the determination mesh. For example, the game system 1 may set at most two types of materials as described above for the vertices to be used for generation of the display mesh, and may set one type of material for the vertices to be used for generation of the determination mesh. Then, the game system 1 may set two types of materials as materials of a polygon of the display mesh, and may set one type of material as a material of a polygon of the determination mesh, based on one type of material that is set for each vertex of this polygon. In setting one type of material for the vertices to be used for generation of the determination mesh, a material having the greatest determination value, among the determination values calculated for each material, may be set as a material of the vertices. Also in this case, as in the exemplary embodiment, the number of types of materials to be set for one polygon in the display mesh may be two at most, and the number of types of materials to be set for one polygon in the determination mesh may be one. Therefore, the information on materials set in the voxel data can be used for (e.g., reflected in) the display mesh, and the process to be performed according to the result of collision determination using the determination mesh is prevented from being complicated.

As described above, in the exemplary embodiment, a display mesh and a determination mesh are set for one voxel object. However, depending on the game situation, both the display mesh and the determination mesh may not necessarily be set for one voxel object at the same time (e.g., both the meshes may not necessarily be set in processing one frame). For example, in the game space, the determination mesh may be generated in a range where collision determination is performed, and may not necessarily be generated in a range where collision determination is not performed. As an example, the game system 1 may generate the determination mesh for voxel objects within a predetermined range around the player character. For voxel objects outside the predetermined range, the game system 1 may generate only the display mesh without generating the determination mesh.

As for the display mesh, the game system 1 may store data regarding the generated mesh in a memory. In frames after generation of the mesh, the game system 1 may use the stored data without executing the mesh generating process again, except for a range where an update is performed. This can decrease the processing load for generating the display mesh. Meanwhile, as for the determination mesh, the game system 1 may not necessarily store data regarding the generated mesh in the memory, and may generate a mesh on an as-needed basis (e.g., each time collision determination is required). This saves memory use for generation of the mesh.

The method for, when voxel data has been changed from its initial state, generating meshes (e.g., a display mesh and a determination mesh) based on the changed voxel data, has been described above. This method can also be used for a case where the meshes are generated based on the voxel data in the initial state when a game is started, for example. However, the meshes based on the voxel data in the initial state may not necessarily be generated based on the voxel data in the initial state when the game is started, and may be prepared in advance of starting the game.

### 2-7. Processing Using Mesh

Next, an example of processing using a mesh generated for a voxel object as described above will be described. Hereinafter, a description will be given of a case where a terrain object such as the ground or a wall is a voxel object, a player character performs an action, and an in-game behavior is generated as a result of collision determination.

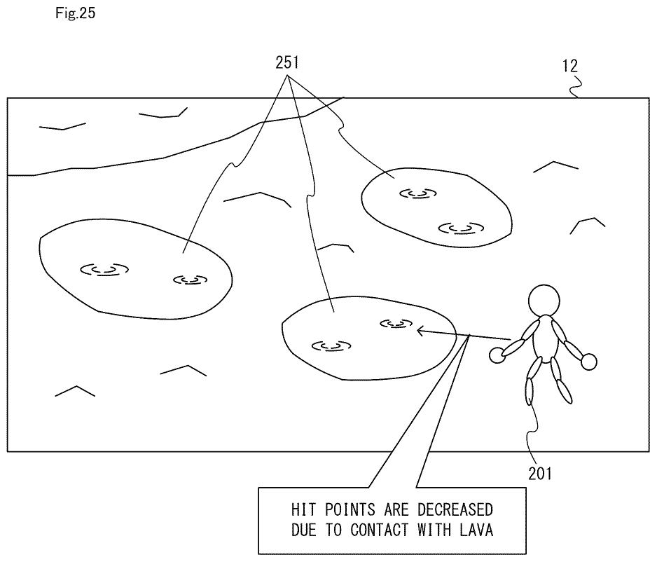

FIG. 25 shows an example of a game image representing a state in which a player character moves on a terrain object. In the example shown in FIG. 25, a material of polygons in partial regions 251 in a determination mesh of the terrain object being the ground is set to “lava”. Meanwhile, a material of polygons other than those in the regions 251 in the determination mesh of the terrain object is set to “rock”. In the example shown in FIG. 25, the game system 1 performs collision determination between the terrain object and the player character 201 by using the determination mesh. That is, the game system 1 performs collision determination as to whether or not the determination mesh of the terrain object comes into contact with a determination region set for the player character (e.g., a region having a predetermined shape that is set based on the position of the player character). When a collision between the polygon whose material is lava and the player character 201 has been determined, a process of reducing the hit points of the player character 201 is performed as a process of generating an in-game behavior. Moreover, in the above case, a process of causing the player character 201 to perform a predetermined reaction is performed.

In the exemplary embodiment, regarding the lava material, a property of reducing the hit points of the player character that has come into contact with the material (e.g., a property of having a temperature equal to or higher than a predetermined value) is set as property information included in the aforementioned material data. The game system 1 generates an in-game behavior (in the above example, reduction in the hit points of the player character) based on the property information corresponding to the material set for the polygon in the determination mesh for which a collision has been determined through the collision determination.

When a collision between a polygon whose material is rock and the player character 201 has been determined, the process of reducing the hit points of the player character is not performed. Based on the collision, the player character 201 is controlled so as not to be able to enter the polygon. Therefore, the player character can stand and walk on the polygon. Thus, in the exemplary embodiment, by setting a material for each polygon, the game system 1 can perform different processes depending on which part of the voxel object another object has come into contact with. In addition, the content of a process to be performed can be matched to the type of the material. In the exemplary embodiment, the player character can change the terrain object (e.g., deform the terrain object, or change the material of the terrain object), and therefore, for example, can delete the lava part of the terrain object, or change the lava to another material. Therefore, by changing the terrain object, the player can avoid a reduction in the hit points of the player character due to contact with the lava.

The content of the process to be performed when a collision between the voxel object and another object has been determined, is discretionary. For example, if the other object is a moving object such as the player character or an enemy character, the process may be a process of outputting the sound of footsteps of the object, or displaying an effect (e.g., effect of representing dust or splash of water) on the contact part. In this case, the game system 1 can change the sound of footsteps or the effect according to the type of the material set for the polygon, in the contact part, of the voxel object.

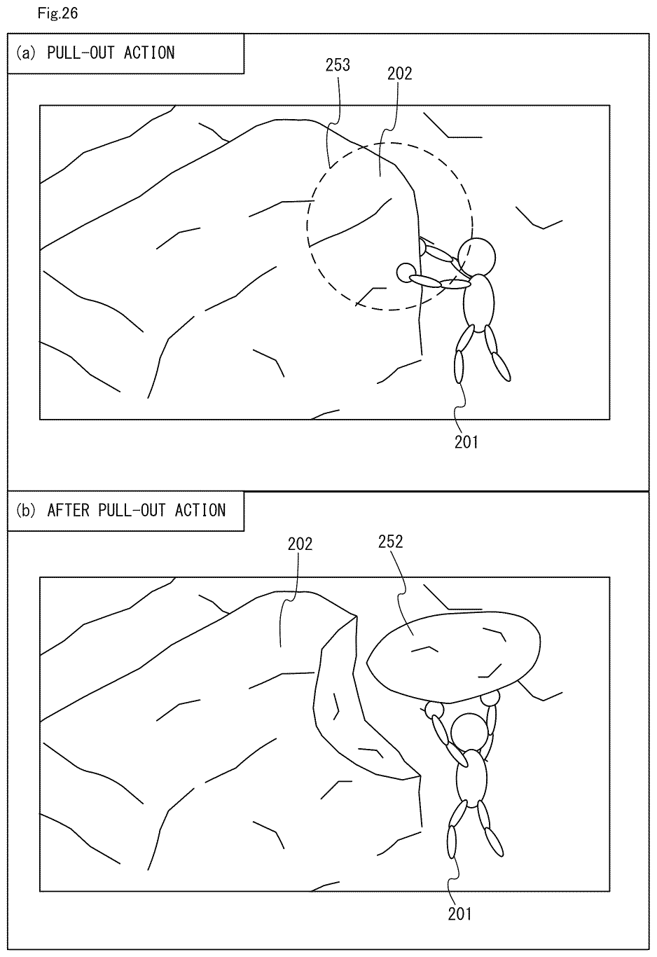

FIG. 26 shows an example of a game image representing a state in which the player character pulls out a fragment object from the terrain object. As shown in FIG. 26, in the exemplary embodiment, the player, through a predetermined operation input, can cause the player character 201 to perform an action of holding the terrain object 202, pulling out a part of the terrain object 202 as a fragment object 252, and grasping the fragment object 252 (hereinafter referred to as “pull-out action”). The game system 1 deletes the part of the terrain object 202 and generates the fragment object 252 as an in-game behavior caused by the pull-out action.

In performing the pull-out action, specifically, the game system 1 executes the following process. That is, when an operation input that causes the player character to perform the pull-out action has been performed by the player, the game system 1 causes the player character to perform an action of digging forward and holding, and performs collision determination. Then, when a collision between the player character performing the pull-out action and the terrain object has been determined, the game system 1 generates an update range 253 based on the position and direction of the player character. For example, the update range 253 is generated in a predetermined direction (e.g., forward) with reference to the player character. The shape and size of the update range may be determined in advance according to the type of the action of the player character. Furthermore, the game system 1 decreases the densities of voxels corresponding to the update range 253. Then, update of the mesh according to the decrease in densities of the voxels causes the terrain object 202 to be deformed such that the part inside the update range 253 is deleted (see (b) of FIG. 26). In the exemplary embodiment, the densities of the voxels corresponding to the update range 253 are decreased. However, voxels whose densities are to be decreased may be at least part of the voxels corresponding to the update range 253.

In the exemplary embodiment, the voxel object corresponding to the update range 253 is unconditionally deformed due to the pull-out action. In other embodiments, the voxel object corresponding to the update range 253 may be deformed on the condition of the amount of damage set for the voxels. For example, instead of unconditionally deforming the voxel object corresponding to the update range 253, the game system 1 may increase the amount of damage set for the voxels corresponding to the update range 253, and decrease the densities of the voxels in response to the amount of damage having exceeded a predetermined value. In this case, the amount of increase in the damage may be determined according to the action performed to the voxel object.

The game system 1 generates the fragment object 252 representing the deleted part of the terrain object 202. That is, based on the pull-out action, the game system 1 generates the fragment object 252 in the state of being held by the player character. The fragment object 252 may be generated so as to have a shape corresponding to the deleted part of the terrain object 202, or a predetermined shape. The fragment object 252 may or may not be a voxel object. When the fragment object is a voxel object, a voxel space different from the voxel space of the voxels corresponding to the terrain object 202 or the like is defined for the fragment object 252.

The game system 1 determines a material of the fragment object 252. The material of the fragment object 252 is determined based on materials set for polygons in a determination mesh that comes into contact with the update range 253 among determination meshes of the terrain object 202. The material of the fragment object 252 is determined to be the same as at least one of the materials set for the polygons in the determination mesh that comes into contact with the update range 253. Thus, the material of the fragment object 252 can be made identical to the material of the deleted part of the terrain object. As is apparent from the above description, the fragment object 252 is actually not a part of the terrain object. However, since the fragment object 252 is generated simultaneously with deletion of a part of the terrain object and takes over the material of the deleted part of the terrain object, an impression that the player character 201 takes out a part of the terrain object 202 by a pull-out action can be given to the player.

In the exemplary embodiment, priorities are set for the types of materials prepared, and the game system 1 determines, as a material of the fragment object 252, a material having the highest priority among the materials set for the polygons of the determination mesh in the update range 253. Here, for example, a case where the determination mesh in the update range 253 includes a polygon whose material is rock and a polygon whose material is lava, is considered. In this case, if the material of the fragment object 252 is set to lava, there is a possibility of inconvenience that the hit points of the player character are reduced because the player character holds the fragment object 252 through the pull-out action (as described with reference to FIG. 25, the lava material has the property of reducing the hit points of the player character if the player character comes into contact with it). Furthermore, as described above, if the determination mesh in the update range 253 includes polygons for which different types of materials are set, it is difficult for the player to predict a material of the fragment object 252, and the above inconvenience may occur against the player's will. Meanwhile, in the exemplary embodiment, since the priorities are given to the materials to be set as a material of the fragment object, the risk of the above inconvenience can be reduced.

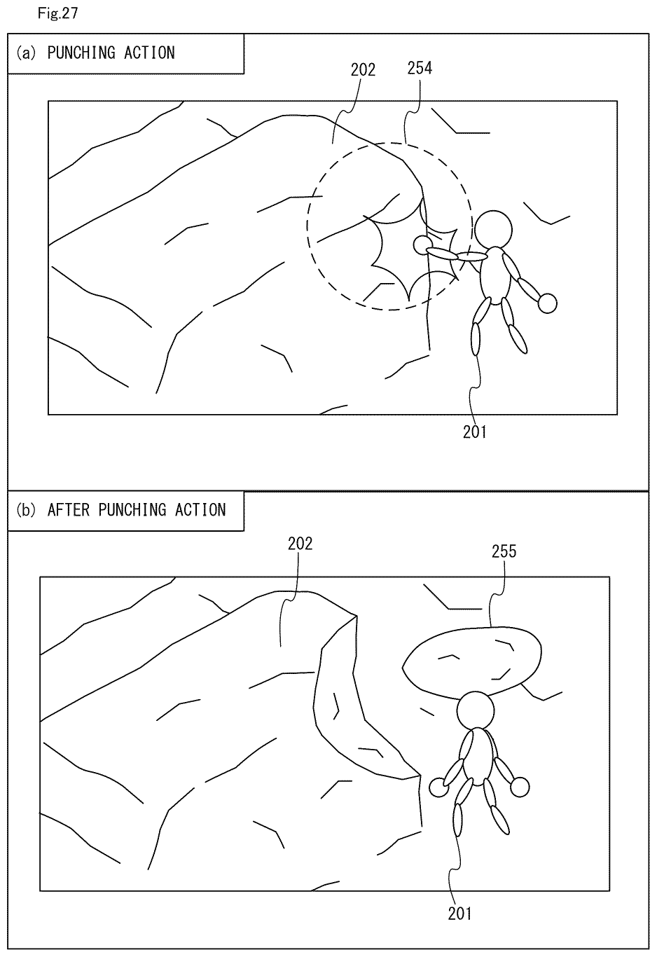

FIG. 27 shows an example of a game image representing a state in which a fragment object is generated because the player character has destroyed the terrain object. As shown in FIG. 27, in the exemplary embodiment, the player, through a predetermined operation input, can cause the player character 201 to perform a punching action. As in the case of the aforementioned pull-out action, the game system 1 deletes a part of the terrain object 202 and generates a fragment object 255, as an in-game behavior caused by the punching action. Specifically, the game system 1 deforms the terrain object 202 such that a part of the terrain object 202 is deleted. In the case of the punching action, unlike the aforementioned pull-out action, the fragment object 255 is not held by the player character 201 but is disposed near the position where the punching action has been performed (see (b) of FIG. 27). Such a fragment according to destruction of the terrain object 202 may not necessarily be generated.

In performing the punching action, specifically, the game system 1 executes the following process. That is, when an operation input to cause the player character to perform the punching action has been performed by the player, the game system 1 causes the player character to perform an action of punching forward, and performs collision determination. Then, when a collision between the player character performing the punching action and the terrain object has been determined, the game system 1 generates an update range 254 based on the position and direction of the player character. For example, the update range 254 is generated in a predetermined direction (e.g., forward) with reference to the player character. The position, shape, and size of the update range 254 due to the punching action may be the same as or different from those of the update range 253 due to the pull-out action. Then, the game system 1 decreases the densities of voxels corresponding to the update range 254. Thus, the terrain object 202 is deformed such that the part inside the update range 254 is deleted by the punching action, similarly to the pull-out action (see (b) of FIG. 27). In the case of the punching action, as in the case of the pull-out action, instead of unconditionally deforming the voxel object corresponding to the update range 254, the game system 1 may increase the amount of damage set for the voxels in the update range 254 according to the punching action, and decrease the densities of the voxels in response to the amount of damage having exceeded a predetermined value. In addition, the voxels whose densities are to be decreased by the punching action may be at least part of the voxels corresponding to the update range 254.

The game system 1 generates a fragment object 255 corresponding to the deleted part of the terrain object 202. That is, based on the punching action, the game system 1 generates the fragment object 255 in the state of not being held by the player character (e.g., in the state of being disposed near the position where the punching action has been performed). The fragment object 255 may be generated so as to have a shape corresponding to the deleted part of the terrain object 202, or a predetermined shape. The fragment object 255 may or may not be a voxel object.

The game system 1 determines a material of the fragment object 255. The material of the fragment object 255 is determined based on materials set for polygons in a determination mesh that comes into contact with the update range 254 among the determination meshes in the terrain object 202. The material of the fragment object 255 is determined to be the same as at least one of the materials set for the polygons in the determination mesh that comes into contact with the update range 254. Thus, the material of the fragment object 255 can be made identical to the material of the deleted part of the terrain object. Since the fragment object 255 is generated simultaneously with deletion of a part of the terrain object and takes over the material of the deleted part of the terrain object, an impression that a part of the terrain object destroyed due to a punching action of the player character is generated as a fragment object can be given to the player.

In the exemplary embodiment, the material of the fragment object 255 is set to a material having the greatest degree of decrease in voxel density among the materials set for the polygons in the determination mesh that comes into contact with the update range 254. This allows generation of a fragment object in which the material composition of the part, of the terrain object, deleted due to the punching action is more accurately shown (e.g., reflected).

The method for determining a material of a fragment object to be generated due to the pull-out action or the punching action is discretionary. For example, the method for determining a material of a fragment object may be the same between the pull-out action and the punching action. Moreover, for example, among the materials set for the polygons of the determination mesh in the update range, a material that is set for the largest number of polygons may be determined as a material of the fragment object. Alternatively, for example, a material that is set for a polygon satisfying a predetermined condition (e.g., a polygon in a position that comes into contact with a hand of the player character performing the pull-out action or the punching action) among the polygons of the determination mesh in the update range, may be determined as a material of the fragment object. In other embodiments, a plurality of types of materials may be set for the fragment object.

In the exemplary embodiment, the player can cause the player character to perform an action of throwing the fragment object 252 or 255 generated as described above (hereinafter referred to as “throwing action”). The player, through a predetermined operation input, can cause the player character to perform an action of holding a fragment object that is generated according to the punching action and placed on the ground. The pull-out action or the action of holding the fragment object after the punching action causes the player character to be in the state of holding the fragment object. In this state, the game system 1 causes the player character to perform an action of throwing the fragment object in a predetermined direction, as the throwing action according to the operation input performed by the player.

FIG. 28 shows an example of a game image of a scene in which a throwing direction is determined while the player character takes a throwing posture, in the state where a throwing action by the player character is possible. As shown in FIG. 28, in the state where the player character 201 is holding a fragment object 261, the player character 201 can perform a throwing action. In this state, as shown in FIG. 28, the game system 1 displays an aim image 262 (e.g., a reticle) and an object information image 263 on the image showing the game space, as a process of generating an in-game behavior.

The aim image 262 indicates a direction (or aim direction) in which the fragment object is thrown due to the throwing action. That is, in response to an operation input performed by the player for the throwing action, the game system 1 moves the fragment object 261 from the position of the player character 201 toward a position, in the virtual space, indicated by the aim image 262. The aim direction is controlled based on an operation input performed by the player. For example, the game system 1 may change the aim direction in response to an operation input for changing the direction of a virtual camera. Specifically, the game system 1 may control the virtual camera according to the operation input such that the virtual camera rotates and moves around the player character while maintaining a state in which the player character is within a field-of-view range, and may control the aim direction to be a direction according to the field-of-view direction of the virtual camera. In this case, the aim image 262 pointing a position where a terrain object 202 intersects a straight line extending in the aim direction from the position of the player character, is displayed. Specifically, the game system 1 performs collision determination between the aim direction (e.g., the straight line extending in the aim direction) and the determination mesh of the terrain object 202, and displays the aim image 262 when a collision has been determined. The aim image 262 is arranged so as to point the position of a polygon, in the determination mesh, which intersects the straight line extending in the aim direction.

The aim image 262 allows the position at which the fragment object comes into contact with the voxel object due to the throwing action of the player character to be presented to the player. This allows the player to easily perform the operation for the throwing action. The specific control method for the aim direction and the aim image 262 is discretionary, and a conventional method may be used. For example, in other embodiments, in the state where the aim image 262 is displayed, the aim image 262 may be displayed in a game image in a first-person viewpoint in which the player character is not displayed.

In the state where the player character takes a posture to throw the fragment object, an action of throwing the fragment object to the aim direction is performed in response to a predetermined operation input performed by the player.

The object information image 263 indicates information regarding the terrain object 202 at the position pointed by the aim image 262. In the exemplary embodiment, the object information image 263 indicates the name of the material (“rock” in the example shown in FIG. 28) set for the polygon of the determination mesh at the position pointed by the aim image 262. Thus, the material of the voxel object with which the fragment object thrown by the throwing action comes into contact can be presented to the player. In addition, the object information image 263 indicates information regarding the property (here, hardness) of the material. Thus, the property of the voxel object with which the fragment object thrown by the throwing action comes into contact can be presented to the player. The object information image 263 may have any content. For example, in other embodiments, the object information image 263 may indicate any property regarding the material that is set for the polygon at the position pointed by the aim image 262, or may indicate the state of the polygon (e.g., the amount of damage described above). In the exemplary embodiment, since one type of material is set for the polygon of the determination mesh, the material corresponding to the aim position is specified to one material. This is suitable for displaying the information regarding the material.

In the exemplary embodiment, in response to the result of the collision determination indicating that the fragment object thrown by the throwing action has come into contact with the voxel object, the game system 1 adds a change to the voxel object as an in-game behavior. FIG. 29 shows an example of a game image after a change is added to the terrain object 202 because the fragment object 261 has come into contact with the terrain object 202 shown in FIG. 28. In the example shown in FIG. 29, the terrain object 202 is deformed such that the fragment object is attached to the contact position between the fragment object and the terrain object 202. Specifically, the game system 1 generates an update range that includes the contact position, and increases the densities of voxels in the update range to deform the terrain object 202 to the aforementioned shape. For example, the update range may be set to a shape corresponding to the shape of the fragment object, and the terrain object 202 may be deformed such that the update range is inside the terrain object 202. As described above, in the example shown in FIG. 29, an additional part 265 is added to the terrain object before deformation. In the example shown in FIG. 29, the fragment object is deleted in response to that it comes into contact with the terrain object 202.

A material of a polygon in the additional part 265 is determined based on the material of the fragment object that has come into contact with the terrain object 202. Specifically, the game system 1 sets the material of voxels in the update range to be the material of the fragment object. Then, materials of the display mesh and the determination mesh are determined based on the material of the voxels. In this case, since the appearance of the attached additional part 265 can be made identical to the appearance of the fragment object, an impression that the fragment object is attached to the terrain object 202 (although the terrain object 202 is deformed in actuality) can be more easily given to the player.

In the example shown in FIG. 29, the change added to the voxel object in response to contact of the fragment object with the voxel object is deformation to add the additional part to the voxel object. However, the change to be added to the voxel object is not limited thereto. The change may be a change in voxel density, or a change in material. For example, if the fragment object has a property of explosion, the fragment object may be exploded in response to contact with the voxel object, and in this case, the voxel object may be deformed as if a part of the voxel object is deleted. Specifically, the game system 1 sets an update range so as to include the contact position, and decreases the voxel density in the update range. In addition, for example, when the material of the voxel object is lava and the material of the fragment object is ice, the material of the voxel object may be changed in response to contact with the fragment object. Specifically, the game system 1 may set an update range including the contact position, and change the material being lava, among the materials of voxels in the update range, to obsidian or rock. This allows representation of a state in which the object of lava is cooled by the object of ice and turns into obsidian or rock.

The content of the change may be determined based on the material of the voxel object, the material of the fragment object, or a combination of the material of the voxel object and the material of the fragment object. This allows occurrence of various changes to the voxel object.

The game system 1 may determine whether or not to perform the above change, based on the material of the voxel object, the material of the fragment object, or a combination of the material of the voxel object and the material of the fragment object. For example, the game system 1 may perform the change as shown in FIG. 29 in the case where the fragment object whose material is rock comes into contact with the voxel object whose material is rock, and may not necessarily perform the change as shown in FIG. 29 when the fragment object whose material is rock comes into contact with the voxel object whose material is iron.

In the exemplary embodiment, one type of material is set for each of the polygons of the determination mesh and for the fragment object. If a plurality of types of materials are set for at least either the polygon of the determination mesh or the fragment object, it is difficult to determine the content of a change to be added to the voxel object according to the types of materials of the determination mesh and the fragment object when they come into contact with each other. Meanwhile, in the exemplary embodiment, since one type of material is set for each of the determination mesh and the fragment object that have been determined to be in contact with each other by the collision determination, it is easy to determine the content of a change to be added to the voxel object.

### 2-8. Game Example

Next, an example of a game performed using a virtual space where a voxel object is placed will be described. The game described below is a racing game in which a plurality of race objects including a player object operated by a player compete in a race. The racing game may be a single-player game with one player object participating, or a multiplayer game with multiple player objects participating.

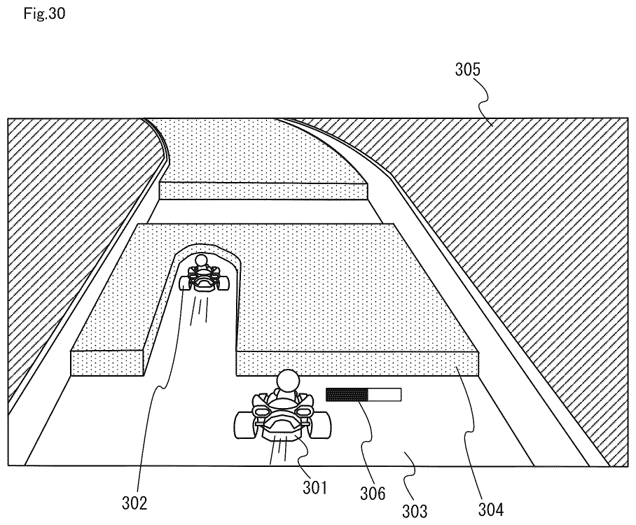

FIG. 30 is a view showing an example of a game image displayed on the game system 1. In the racing game, a game image representing a state in which a plurality of race objects including a player object 301 travel on a racing course. In the exemplary embodiment, the player object 301 includes a player character and a vehicle object. The vehicle object that the player character rides may be any object such as a car, an airplane, an animal, or another character. The player object may be composed of a single object.

In the exemplary embodiment, in the virtual space, a ground object 303, a soil object 304, and a mud object 305 are arranged as objects constituting a terrain. In the exemplary embodiment, the soil object 304 is a voxel object to which a soil material is assigned. The mud object 305 is a voxel object to which a mud material is assigned. As will be described in detail below, as for the soil object 304 or the mud object 305, if a voxel update range is set and the density thereof is updated during the game, the object is deformed, for example, as if a part thereof is deleted. In the exemplary embodiment, the ground object 303 is an object that is not deformed even when a voxel update range is set. For example, the ground object 303 is either an object that is not a voxel object or a voxel object to which a material that does not deform is assigned. In the exemplary embodiment, the voxel objects such as the soil object, the mud object, and a traveling road object described later are arranged within a region on the ground object 303. Specifically, a voxel space for these voxel objects is set to include a region on the ground object 303.

During the race, the race objects such as the player object 301 and a race object 302 are controlled to travel in the virtual space. The player object 301 is controlled based on an operation input performed by the player. In the exemplary embodiment, as for the player object 301, its movement speed is determined based on control rules defined in the game program, and its traveling direction is determined based on an operation input performed by the player. The player object 301 may be controlled by any control method, and the movement speed and the traveling direction may be determined based on an operation input performed by the player. Meanwhile, as for a race object not operated by the player, its movement speed and traveling direction are determined based on the control rules defined in the game program.

In the exemplary embodiment, the race object, during movement, can deform the soil object 304 and the mud object 305 as if they are deleted. Specifically, the game system 1 sets a voxel update range in front of the race object, and updates voxels corresponding to the voxel update range by reducing the densities thereof (e.g., by setting the densities to 0). This causes the meshes of the soil object 304 and the mud object 305 to be deformed such that portions within the voxel update range are deleted. Thus, it is possible to represent the race object traveling while destroying or absorbing the soil object 304 or the mud object 305. The specific position, size, and shape of the voxel update range are discretionary. For example, the voxel update range may have a spherical shape centered on a position a predetermined distance ahead of the race object.

In the exemplary embodiment, the race object can perform a generation action to generate a voxel object. In the exemplary embodiment, when the race object has performed a generation action, a voxel object is placed along the trajectory that the race object has passed during the generation action, after movement of the race object. As will be described in detail below, the race object can travel on the placed voxel object. Hereinafter, a voxel object generated due to a generation action is referred to as a traveling road object. In the exemplary embodiment, since the traveling road object is generated during the racing game, the route where the race object can travel is dynamically changed during the game, thereby improving the strategy and interest of the racing game.

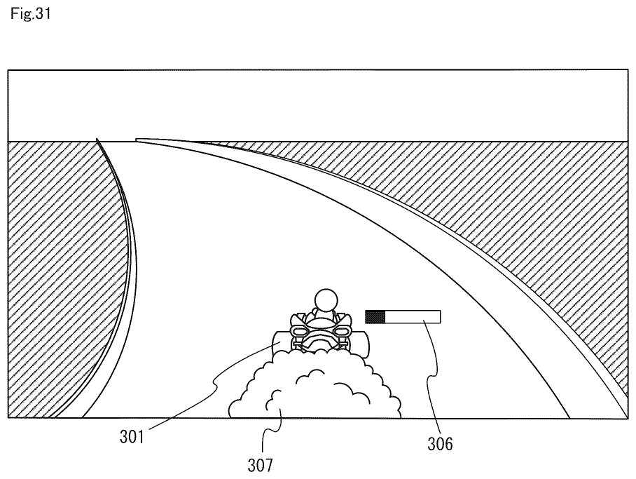

FIG. 31 is a view showing an example of a game image representing the player object performing a generation action. In the exemplary embodiment, the player object 301 performs a generation action in response to a predetermined operation input (e.g., an input to the ZR-button 61) performed by the player. In the exemplary embodiment, the player object 301 performing the generation action moves forward, or forward and diagonally upward. The movement direction during the generation action is discretionary, and the race object during the generation action may move along the ground object or may move as if jumping into the air. The movement direction during the generation action may be determined based on an operation input performed by the player. For example, the angle of the movement direction regarding the pitch direction (specifically, the angle of the movement direction with respect to the horizontal direction) may be, within a predetermined angle range, determined to an angle according to the operation input during the generation action. Specifically, the movement direction regarding the pitch direction during the generation action may be determined within a range from the horizontal direction to a predetermined angle upward with respect to the horizontal direction, according to an operation input (e.g., an input by tilting the analog stick 32) during the generation action. In other embodiments, the movement mode of the race object may not necessarily change when the generation action is started. That is, the game system 1 may determine the movement speed and the traveling direction of the race object in the same manner, regardless of whether or not the race object performs a generation action.

In the exemplary embodiment, the movement speed of the race object during the generation action is set to a speed higher than the movement speed when not performing a generation action. The movement speed during the generation action is discretionary. In other embodiments, the movement speed during the generation action may be the same as or lower than the movement speed when no generation action is performed.

In the exemplary embodiment, the race object is assigned an action parameter with a value corresponding to the time during which a generation action can be executed. The game system 1 increases the value of the action parameter according to the race object satisfying a predetermined condition. In the exemplary embodiment, the game system 1 increases the value of the action parameter in response to that the race object deforms the soil object or the mud object as if it is deleted. In addition, the game system 1 gradually decreases the value of the action parameter during the period when the race object is performing the generation action. The game system 1 causes the race object to perform a generation action at least on the condition that the value of the action parameter is not 0. When the value of the action parameter is 0, even if an operation input for a generation action regarding the player object is performed, the game system 1 causes the race object to end the generation action. Thus, in the exemplary embodiment, by controlling the player object 301 to deform the soil object or the mud object, the player can increase the value of the action parameter and thereby cause the player object 301 to perform a generation action.

As shown in FIG. 30 and FIG. 31, the game system 1 may display a gauge image 306 indicating the current value and an upper limit value of the action parameter. In addition, the game system 1 may display an effect image regarding the race object during the generation action to notify the player that the generation action is in progress. For example, in the example shown in FIG. 31, an effect image 307 representing smoke is displayed behind the player object 301.

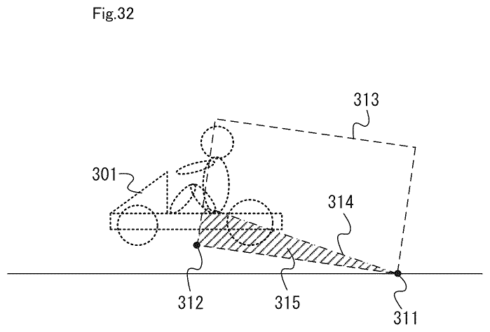

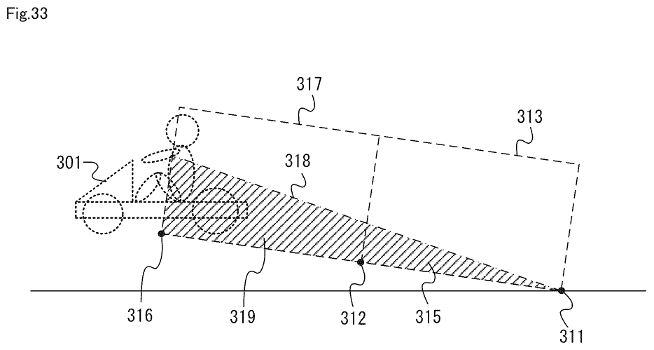

Next, with reference to FIG. 32 and FIG. 33, a process of generating a traveling road object according to a generation action will be described. FIG. 32 is a view showing an example of a voxel update range that is set at a point when one frame has elapsed from when a generation action was started. In the example shown in FIG. 32, a start position 311 is the position of the player object 301 when a generation action is started. The current position 312 is the position of the player object 301 at the current time (here, after one frame has elapsed from the start of the generation action). In the exemplary embodiment, the position of the player object 301 is set at a predetermined position on a horizontal plane including a lower end of the player object 301 (see FIG. 32).

In the exemplary embodiment, the game system 1 sets a passage area 313 along a path through which the player object 301 performing the generation action passes. In the situation shown in FIG. 32, the passage area 313 is set to extend from the start position 311 to the current position 312. For example, the passage area 313 has a rectangular parallelepiped shape having four side surfaces parallel to the direction from the start position 311 to the current position 312, and one of two surfaces other than the side surfaces (hereinafter referred to as a bottom surface) includes the start position 311 while the other surface includes the current position 312. Moreover, one side of the bottom surface of the passage area 313 passes the start position 311 and is parallel to the ground at the start position 311. The passage area may have any shape extending from the start position to the current position. For example, the passage area may have a capsule shape or a shape with rounded vertices and sides of the above-mentioned rectangular parallelepiped. The passage area may also have a shape such that an upper portion of a cross section perpendicular to the direction extending from the start position to the current position forms a straight line. Thus, an upper surface of the traveling road object is formed, allowing the traveling road object to have a shape on which the race object can easily travel.

As described above, the passage area 313 is set to include the position through which the player object 301 performing the generation action passes. However, the passage area 313 may not necessarily be set to include the entire area through which the player object 301 passes, and may be set to include an area through which the player object 301 does not pass. In the exemplary embodiment, the game system 1 represents the passage area 313 by using the aforementioned SDF.

Next, the game system 1 sets a slope 314 inside the passage area 313. As shown in FIG. 32, the slope 314 is a plane obtained by rotating the lower side surface (specifically, side surface including the start position 311 and the current position 312) of the passage area 313 upward by a predetermined angle, using an edge passing through the start position 311 as a rotation axis. The predetermined angle is greater than 0° and less than 90°. As will be described in detail below, the upper surface of the traveling road object is generated along the slope 314. Here, if the upper surface of the traveling road object and the ground are connected at the start position 311 such that no large angle difference occurs, the race object can move more easily onto the traveling road object. Therefore, the predetermined angle may be set to an angle equal to or less than 45° (e.g., 10°). In the exemplary embodiment, since the position on the horizontal plane including the lower end of the race object is used as the position of the race object, the predetermined angle is set to a value greater than 0°. However, a position other than the horizontal plane including the lower end of the race object may be used as the position of the race object, and in this case, the predetermined angle may be set to 0°.

The game system 1 sets, as a voxel update range 315, a portion of the passage area 313 excluding a portion located above the slope 314 (see a hatched area shown in FIG. 32). Specifically, the game system 1 changes data of SDF representing the passage area 313 to represent the area excluding the area located above the slope 314. The game system 1 updates (specifically, increases) the densities of voxels corresponding to the voxel update range 315 so that a voxel mesh is arranged on the surface of the voxel update range 315 obtained as described above. For example, the densities of voxels corresponding to the voxel update range 315 are updated to the upper limit value (specifically, 255). The game system 1 generates a voxel mesh of the traveling road object based on the voxel data after the update of densities, according to the method described in the above [2-6. Generation of mesh]. Thus, the traveling road object having the shape corresponding to the voxel update range 315 is generated.

FIG. 33 is a view showing an example of a voxel update range that is set at a point when two frames have elapsed from when a generation action was started. In the exemplary embodiment, during the generation action, the race object moves straight in the direction determined at the start of the action. Therefore, in FIG. 33, a current position 316 is on a straight line passing through a start position 311 and a one-frame previous position 312.

After the second frame onward from the start of the generation action, the game system 1 sets a passage area in the same manner as in the first frame. In the second and subsequent frames, the passage area is set to extend from the position of the player object 301 in the previous frame to the current position. In the second frame, a passage area 317 extending from the one-frame previous position 312 to the current position 316 is set (see FIG. 33). As described above, in the exemplary embodiment, since the race object performing the generation action moves straight, an upper side surface of the 1-frame previous passage area 313 and an upper side surface of the passage area 317 set in the current frame are continuous. The race object performing the generation action may be controlled so as not to move straight (e.g., moving along a parabolic trajectory). In this case, the game system 1 may adjust the position of the passage area 317 such that the upper side surface of the 1-frame previous passage area 313 and the upper side surface of the passage area 317 set in the current frame are continuous.

Next, the game system 1 sets a slope 318 within the passage area 317. In the second and subsequent frames, in the same manner as in the first frame, the slope 318 is a plane obtained by rotating the lower side surface of the passage area 317 upward by a predetermined angle, using the edge passing through the start position 311 as a rotation axis. In the exemplary embodiment, since the race object performing the generation action moves straight, the slopes set in the respective frames are located on the same plane. If the race object performing the generation action is controlled so as not to move straight, the game system 1 may adjust and set the position of the slope such that the 1-frame previous slope and the slope set in the current frame are continuous.

In the second and subsequent frames, as in the first frame, the game system 1 sets, as a voxel update range 319, a portion of the passage area 317 excluding a portion above the slope 318 (see a hatched area shown in FIG. 33). The densities of voxels corresponding to the voxel update range 319 are updated such that a voxel mesh is arranged on the surface of the voxel update range 319, and a voxel mesh of the traveling road object is set based on the voxel data after the update of densities. Thus, in the second and subsequent frames, the traveling road object is deformed to have a shape corresponding to the voxel update ranges (voxel update ranges 315 and 319 in the example shown in FIG. 33) that have been set so far. Thus, in the exemplary embodiment, the traveling road object is deformed to extend along the traveling direction of the player object 301.

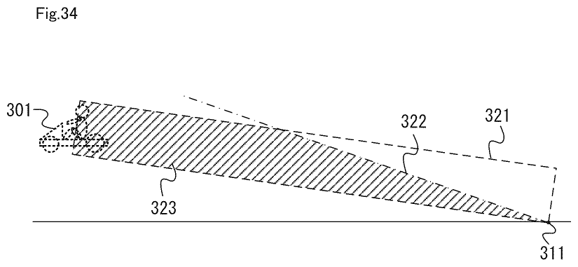

FIG. 34 is a view showing an example of a voxel update range that is set after a certain time has elapsed from when a generation action was started. In FIG. 34, an area 321 is obtained by combining all the passage areas set from the start of the generation action up to the present time. Here, as shown in FIG. 34, the slope 322 is located above the upper side surface of the area 321, at a position a certain distance away from the start position 311. That is, in a frame after a certain time has elapsed from the start of the generation action, the slope 322 is located above the upper side surface of the passage area in the frame. In this case, the passage area is set as a voxel update range as it is. Thus, in the exemplary embodiment, a voxel update range 323 has a shape obtained by excluding an upper portion, of the area 321, on the side near the start position 311 (see FIG. 34).

Specifically, in the frames from the start of the generation action until a predetermined exclusion processing period has elapsed, the game system 1 performs a process of excluding an upper portion, of the passage area, above the slope. In a frame after the exclusion processing period has elapsed, the game system 1 sets the passage area as a voxel update range without performing the process. The exclusion processing period is a period before the frame in which the slope comes to be located above the upper side surface of the passage area. Thus, the traveling road object generated within the exclusion processing period from the start of the generation action has an upper surface along the slope. This makes it possible to reduce (or eliminate) the step between the ground and the traveling road object, allowing the race object to easily enter the traveling road object from the ground. In other embodiments, a voxel update range may be set without using a slope. Specifically, the game system 1 may set a passage area before excluded by the slope, as a voxel update range.

In the exemplary embodiment, the upper side surface of each passage area set for each frame, and each slop for each frame, are set to be continuous. Therefore, the voxel mesh of the traveling road object is generated such that the upper surface generated due to deformation in each frame is continuous with the upper surfaces having been formed up to that point. Thus, the traveling road object can be generated in a shape that allows the race object to easily travel on the traveling road object.

In the exemplary embodiment, the game system 1 sets a voxel update range for each frame, and sets a voxel mesh of a traveling road object for each frame such that its shape corresponds to the voxel update range. Therefore, the voxel update range is continuously set at positions passed by the race object through the generation action, and the traveling road object is deformed to gradually extend along the path traveled by the race object. This makes it possible to clearly represent how the traveling road object is generated according to the generation action such that it follows the race object.

The method for continuously setting the voxel update range is not limited to the method for setting the voxel update range for each frame. For example, in other embodiments, on the condition that the distance between the current position of the race object and the one-frame previous position is equal to or greater than a predetermined distance, the game system 1 may perform the passage area setting process and the voxel update range setting process, based on these positions. If these setting processes were not performed in the preceding frame, on the condition that the distance between the current position of the race object and the two-frame previous position is equal to or greater than a predetermined distance, these setting processes are performed based on these positions. In this case as well, the voxel update range is continuously set and the traveling road object is continuously deformed according to the generation action being performed over a plurality of frames.

The game system 1 may not necessarily perform the voxel update range setting process and the voxel mesh setting process for the traveling road object, based on the current position of the race object in a certain frame in which the generation action is being performed, in this frame, and may perform these processes in a later frame. In the exemplary embodiment, when the race object during the generation action has reached a certain position in a certain frame, the game system 1 performs a setting process for a voxel update range calculated with the certain position as a current position and a voxel mesh setting process for a traveling road object based on the voxel update range, in a frame after a waiting period from this frame. Therefore, the voxel mesh for the traveling road object, which is set at a certain position in response to the race object passing through the position, is set after the waiting period has elapsed after the passing of the race object. Thus, the risk of contact between the race object and the traveling road object can be reduced. For example, the risk of issues such as the race object moving unnaturally due to contact can be reduced. The waiting period may be fixedly set in advance, or may be variably set based on the movement speed of the race object, or the like. For example, the waiting period may be set to a shorter period when the race object moves at a higher speed, and to a longer period when the race object moves at a lower speed.

In other embodiments, the game system 1 may perform the voxel mesh setting process for the traveling road object after the generation action by the race object has ended. In this case, the game system 1 can set a traveling road object that extends along the movement path of the race object during the period of the generation action. For example, as in the exemplary embodiment, the game system 1 can deform the traveling road object such that it gradually extends by performing the passage area setting process and the voxel update range setting process continuously according to the position of the race object for each frame. The traveling road object may be deformed so as to extend along the movement path of the race object, and it is not necessary for the extending direction of the traveling road object to completely coincide with the movement path of the race object when viewed partially. For example, the traveling road object may be deformed so as to extend in a meandering manner from the start position of the generation action to the end position of the generation action. For example, the traveling road object may be formed such that the slope of the upper surface thereof near the start position and the end position of the generation action is gentler than the slope of the upper surface in the intermediate portion between the start position and the end position.

The voxel space for the traveling road object may be the same as or different from the voxel space for other voxel objects (e.g., soil object and mud object). For example, if the voxel space for the traveling road object is different from that for the other voxel objects, the entire traveling road object can be easily deleted by, for example, setting the density of each voxel in the voxel space to 0.

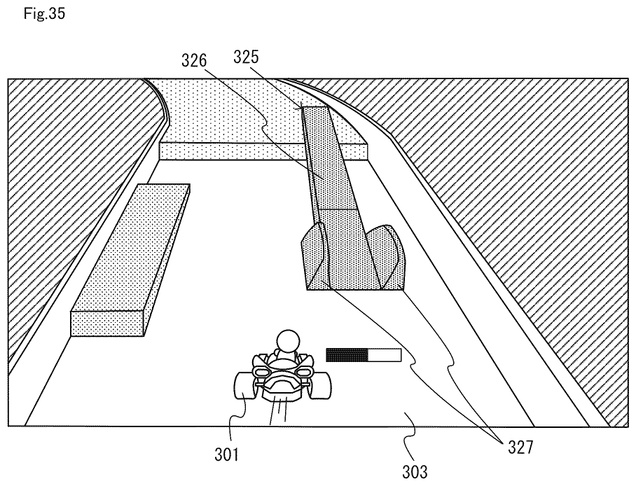

FIG. 35 is a view showing an example of a game image after a traveling road object has been generated. In the situation shown in FIG. 35, a traveling road object 325 is placed on the ground object 303. In the exemplary embodiment, the race object can move on the ground object, and can travel on the traveling road object disposed on the ground object. As shown in FIG. 35, since the traveling road object 325 can be disposed to extend diagonally upward from the ground object 303, the route with the traveling road object 325 can be different from the route on the ground object 303, for example. Thus, the position where the traveling road object is generated affects the outcome of the racing game, thereby improving the strategy of the racing game.

In the exemplary embodiment, the racing course is annular, and the racing game follows a rule that requires a plurality of laps around the annular racing course. Therefore, the player object 301 can place the traveling road object through its own generation action, for example, and then travel on the traveling road object in the next and subsequent laps. Thus, the strategy of the racing game can be further improved. The annular course refers to a course of any shape that allows for laps, for example, a course that includes a closed path. The annular course may also refer to a course that forms a track. In other embodiments, the shape of the racing course may be any shape, and need not be annular. In addition, the racing game may adopt a rule that requires only a single lap of an annular course.

In the exemplary embodiment, the traveling road object 325 has, in addition to a traveling surface part 326 based on the voxel update range that is set according to the method shown in FIGS. 32 to 34, guide parts 327 located outside the traveling surface part 326 (specifically, outside in the left-right direction when the direction in which the player object travels due to the generation action is the forward direction). Specifically, in the frame in which the generation action is performed by the race object, the game system 1 sets a voxel update range (e.g., the voxel update range 315 shown in FIG. 32) based on the above passage area, and further sets a voxel update range for the guide part outside the voxel update range. The game system 1 performs update to increase the densities of voxels corresponding to these voxel update ranges. The shape of the guide part and the shape of the voxel update range corresponding to the guide part are discretionary. For example, the voxel update range for the guide part may be set not only in an area outside the traveling surface part but also in an area overlapping with the traveling surface part. The shapes of the guide part and the corresponding voxel update range may be determined in advance. For example, these shapes may extend to the position above the upper side surface of the passage area, or the slope (see FIG. 35). In the exemplary embodiment, the guide parts 327 are generated within a range of a predetermined distance from the start position of the generation action, regarding the direction in which the traveling surface part extends. For example, the game system 1 may perform the process of setting the voxel update range for the guide part, during a period until a predetermined number of frames elapse from the start of the generation action, and may not perform the process after the period has elapsed. In other embodiments, the guide parts 327 may be generated outside the traveling surface part 326 within a range from the start position to the end position of the generation action.

The guide parts 327 make it easier for the race object to enter the traveling road object 325. Also, the guide part 327 makes it easier for the player to recognize the start position of the traveling road object 325.

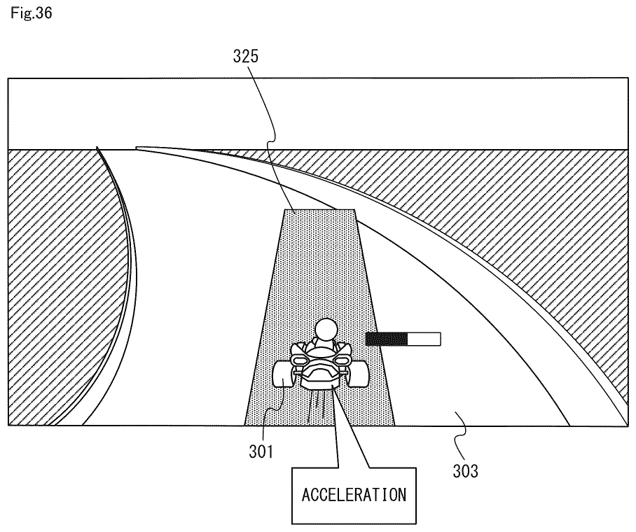

FIG. 36 is a view showing an example of a game image when a player object moves on a traveling road object. In the exemplary embodiment, when moving on the traveling road object 325, the player object 301 is controlled to accelerate. Specifically, when updating the density in the voxel update range corresponding to the traveling road object, the game system 1 sets the material of voxels corresponding to the voxel update range to a predetermined material having the property of accelerating an object that moves on the object of the material (referred to as “traveling road material”). Thus, the voxel mesh of the traveling road object is set to the traveling road material. When performing a control to move the race object during the racing game, the game system 1 specifies which object the race object is located on, and if it is located on an object of the above traveling road material, the game system 1 performs a control to accelerate the race object. The specific control method for accelerating the race object is discretionary. For example, during a period when acceleration is performed, the game system 1 may increase the movement speed of the race object gradually from the current speed, or may change the movement speed during the period when acceleration is performed to a constant speed higher than the normal speed. Thus, the player can advantageously progress the racing game by making the player object 301 travel on the traveling road object. Thus, the strategy of the racing game in which the traveling road object is placed can be further improved.

As described above, in the exemplary embodiment, the soil object and the mud object are placed on the ground object, and the race object travels while deforming these objects such that portions of the objects in its traveling direction are deleted. In the exemplary embodiment, the game system 1 sets the movement speed of the race object when the mud object is deformed due to movement of the race object to a speed lower than the movement speed when the soil object is deformed due to movement of the race object. This encourages the player to think about avoiding the mud object or passing over the mud object by using the generation action or the traveling road object, thereby further improving the strategy of the racing game. In other embodiments, the number of types of voxel objects to be deformed by movement of the race object is discretionary, and may be three or more, or one. In other embodiments, voxel objects of types that are deformed by movement of the race object may not necessarily be placed on the ground object.

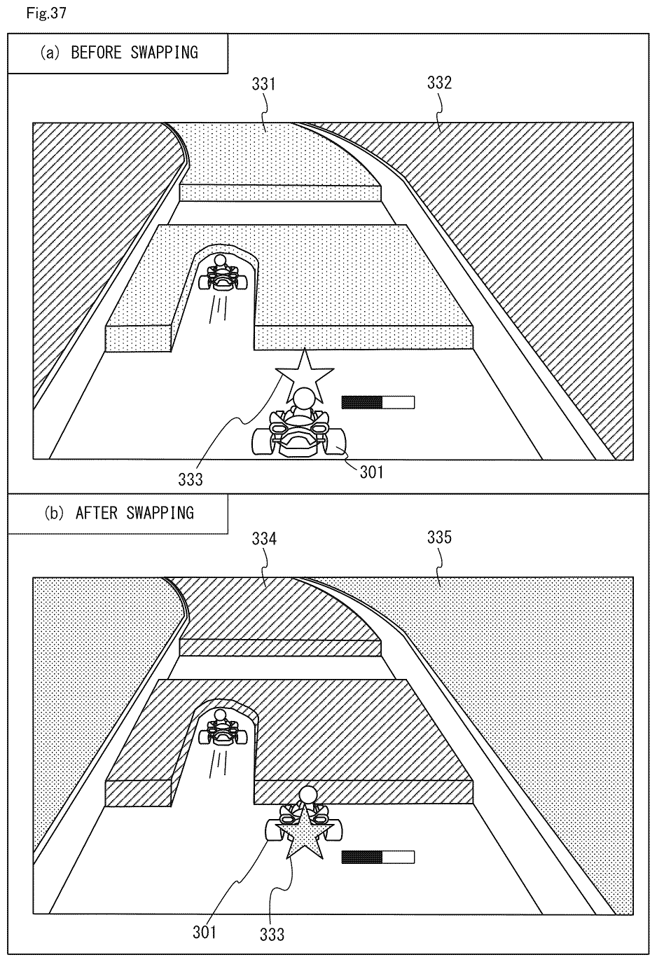

In the exemplary embodiment, the positions of the soil object and the mud object may be swapped during the game. FIG. 37 is a view showing an example of game images before and after swapping of the soil object and the mud object. In FIG. 37, (a) shows the situation before swapping, and a soil object 331 is placed on the racing course while a mud object 332 is placed outside the racing course. The soil object 331 and the mud object 332 may be placed anywhere. A part or the entirety of the mud object may be placed on the racing course, or a part or the entirety of the soil object may be placed outside the racing course.

In the exemplary embodiment, when such a swap event has occurred during the racing game, the positions of the soil object 331 and the mud object 332 are swapped. In the exemplary embodiment, a swap object 333 is placed in the virtual space, and the swap event is an event in which the race object passes over the swap object 333. The specific content of the swap event is discretionary. For example, in other embodiments, the swap event may be the race object using a predetermined item, or a predetermined period of time having elapsed from the start of the race. The swap event may be an event generated by the race object as in the exemplary embodiment, an event generated only by the player object, or an event generated regardless of behavior of the race object.

In FIG. 37, (b) shows the situation after the swap event has occurred. In this situation, the soil object 331 before generation of the swap event has become a mud object 334, and the mud object 332 before generation of the swap event has become a soil object 335. In the example shown in FIG. 37, before the swapping, the soil object was placed on the racing course, so that the race object could travel more advantageously than outside the racing course where the mud object is placed. In contrast, after the swapping, the mud object is placed on the racing course, so that the race object travels less advantageously than outside the racing course where the soil object is placed. In this way, by swapping the materials of objects during the game, the game situation can be changed, thereby improving the strategy of the game.

In the exemplary embodiment, the game system 1 performs swapping of objects as described above by updating the above material data (FIG. 12). Specifically, when a swap event has occurred, the game system 1 swaps the ID of the soil material and the ID of the mud material in the material data. For example, if the ID of the soil material is “001” and the ID of the mud material is “005” before the swapping, the game system 1 changes the ID of the soil material to “005” and changes the ID of the mud material to “001”. This makes it possible to change the material set for each voxel without changing the material ID set on each voxel, as indicated by the voxel data. This allows swapping of the materials of voxel objects with less processing load.

As described above, in the exemplary embodiment, swapping of materials of voxel objects is performed by changing the type of material (specifically, the type indicated by material ID) rather than changing data of the material set for voxels. In other embodiments, swapping of materials of voxel objects may be performed by any method. For example, the game system 1 may add flag data in voxel data, and switch the on/off state indicated by the flag data in response to occurrence of a swap event. In this case, the game system 1 switches the material set for a voxel depending on whether the flag data indicates ON or OFF. For example, the game system 1 may also switch the material set for a voxel by updating data of material ID included in voxel data.

### 3. Specific Example of Processing in Game System

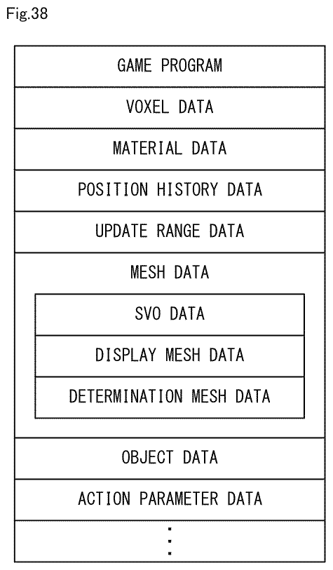

Next, a specific example of information processing in the game system 1 will be described with reference to FIG. 38-FIG. 43.

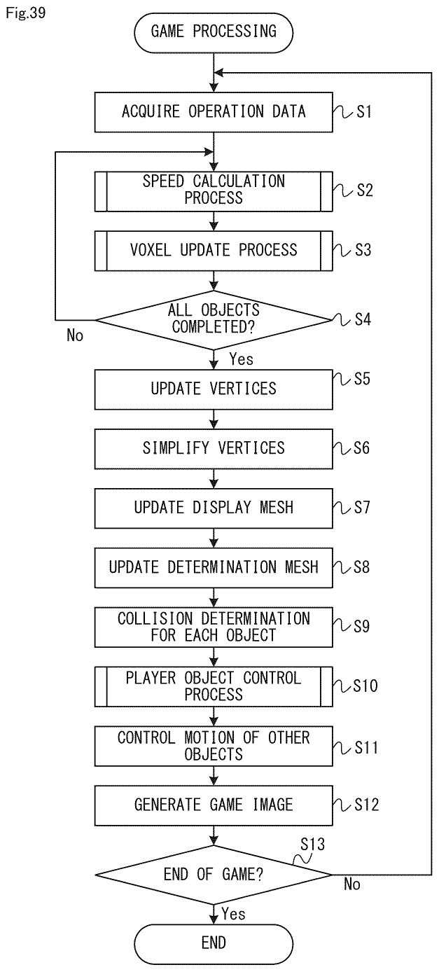

FIG. 38 shows an example of various data used for information processing in the game system 1. The data shown in FIG. 38 are stored in a memory (e.g., the flash memory 84, the DRAM 85, and/or a memory card attached to the slot 23) that is accessible by the main body apparatus 2. As shown in FIG. 38, the game system 1 stores a game program therein. The game program is a program for executing game processing (specifically, game processing shown in FIG. 39) in the exemplary embodiment. The game program includes the aforementioned material data (see FIG. 12). In the memory, the aforementioned voxel data (see FIG. 11), the aforementioned material data (see FIG. 12), position history data, update range data, mesh data, object data, action parameter data, and the like are stored (see FIG. 38).

The position history data is data indicating the history of positions of the race object. Specifically, the position history data includes: data indicating the current position of the race object at the time when a generation action is performed; and data capable of specifying an elapsed time from the start of the generation action to the time. The data capable of specifying the elapsed time may be, for example, data indicating the time from the start of the generation action, or data indicating the number of frames from the start of the generation action.

The mesh data includes various data regarding meshes of a voxel object. As shown in FIG. 38, in the exemplary embodiment, the mesh data includes SVO data, display mesh data, and determination mesh data. The SVO data is data in which vertices calculated from the voxel data are held by the aforementioned SVO structure. In the exemplary embodiment, the SVO data includes data indicating materials set for the vertices (e.g., data indicating IDs of the materials) in addition to data indicating the positions of the vertices. The display mesh data includes various data regarding a display mesh. Specifically, the display mesh data includes data indicating vertices of the display mesh, and data indicating materials set for the vertices (e.g., data indicating IDs of the materials). The determination mesh data includes various data regarding a determination mesh. Specifically, the determination mesh data includes data indicating vertices of the determination mesh, and data indicating materials set for the vertices (data indicating IDs of the materials).

The object data includes various data regarding objects (e.g., the race object, etc.) other than the voxel object. The object data is stored for each object that appears in the game space. The object data includes data indicating, for example, the position, speed, state, etc., of the object.

The action parameter data indicates the value of the above action parameter. The action parameter data is stored for each race object. At the start of the game, the action parameter data indicating a predetermined value (e.g., 0) is stored.

FIG. 39 is a flowchart showing an example of a flow of game processing executed by the game system 1. The game processing shown in FIG. 39 is game processing for progressing the racing game described in the above [2-8. Game example]. Execution of the game processing is started in response to the game having been started according to an instruction of the player, during execution of the game program, for example. A processing loop composed of a series of processes in steps S1 to S13 is performed in a cycle of once for each frame.

In the exemplary embodiment, the processor 81 of the main body apparatus 2 executes the game program stored in the game system 1 to execute processes in steps shown in FIG. 39. However, in other embodiments, a part of the processes in the steps may be executed by a processor (e.g., a dedicated circuit or the like) other than the processor 81. Further, if the game system 1 is communicable with another information processing apparatus (e.g., a server), a part of the processes in the steps shown in FIG. 39 may be executed by the other information processing apparatus. The processes in the steps shown in FIG. 39 are merely examples, and the processing order of the steps may be changed, or another process may be executed in addition to (or instead of) the processes in the steps as long as similar results can be obtained.

The processor 81 executes the processes in the steps shown in FIG. 39 by using a memory (e.g., the DRAM 85). That is, the processor 81 stores information (in other words, data) obtained in each process step, into the memory, and reads out the information from the memory when using the information for the subsequent process steps.

In step S1 shown in FIG. 39, the processor 81 acquires the operation data indicating an operation input performed by the player. That is, the processor 81 acquires the operation data received from the respective controllers via the controller communication section 83 and/or the terminals 17 and 21. Next to step S1, the process in step S2 is executed.

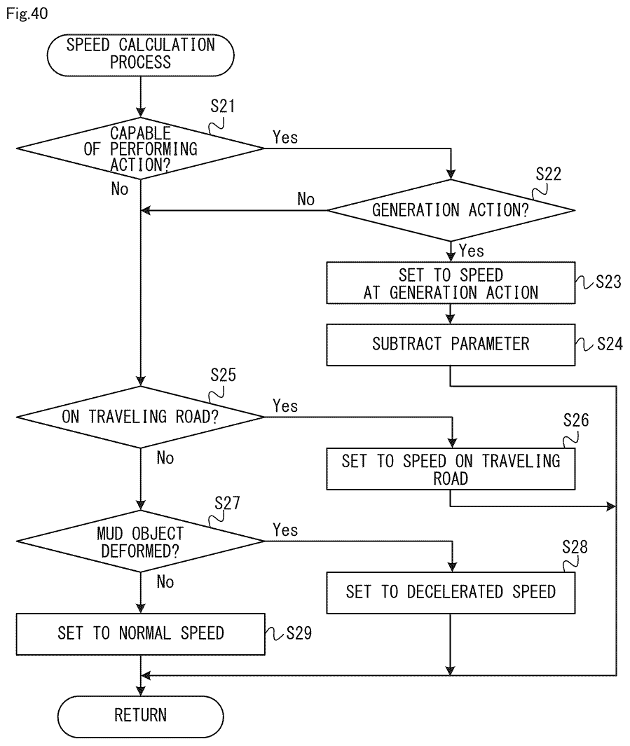

In step S2, the processor 81 designates one object as a processing target, among the objects in the game space that require processing (here, race objects), which has not been completed in processing, and subjects the designated object to a speed calculation process of calculating a movement speed. Hereinafter, the speed calculation process in step S2 will be described with reference to FIG. 40.

FIG. 40 is a sub flowchart showing an example of a specific flow of the speed calculation process in step S2 shown in FIG. 39. In the speed calculation process, first, in step S21, the processor 81 determines whether or not the race object is capable of performing a generation action. Specifically, the processor 81 refers to the action parameter data stored in the memory, and determines whether or not the action parameter of the race object designated as a processing target is 0. When the determination result in step S21 is positive, the process in step S22 is executed. When the determination result in step S21 is negative, the process in step S25 is executed.

In step S22, the processor 81 determines whether or not to perform a generation action with respect to the race object. When the race object is a player object, the processor 81 determines whether or not an operation input for a generation action has been performed, based on the operation data acquired in step S1. When the race object is other than the player object, the processor 81 determines whether or not to perform a generation action, based on the control rule regarding the race object. When the determination result in step S22 is positive, the process in step S23 is executed. When the determination result in step S22 is negative, the process in step S25 is executed.

In step S23, the processor 81 sets the movement speed of the race object to a speed used when a generation action is performed. In the exemplary embodiment, the movement speed when a generation action is performed is higher than the normal speed (step S29 described below). The processor 81 updates the object data stored in the memory for the race object so that the data indicates the set speed. Next to step S23, the process in step S24 is executed.

In step S24, the processor 81 performs subtraction on the action parameter of the race object. Specifically, the processor 81 updates the action parameter data stored in the memory for the race object so that the data indicates a value obtained by subtracting a predetermined amount from the value before the update. After step S24, the processor 81 ends the speed calculation process.

In step S25, the processor 81 determines whether the race object is located on the traveling road object. When the determination result in step S25 is positive, the process in step S26 is executed. When the determination result in step S25 is negative, the process in step S27 is executed.

In step S26, the processor 81 sets the movement speed of the race object to a speed used when the race object travels on the traveling road object. In the exemplary embodiment, the speed when the race object travels on the traveling road object is higher than the normal speed (step S29 described below). The processor 81 updates the object data stored in the memory for the race object so that the data indicates the set speed. After step S26, the processor 81 ends the speed calculation process.

In step S27, the processor 81 determines whether or not the mud object has been deformed by the race object through the process in the previous frame (specifically, the previous process loop of steps S1 to S13). The determination process in step S27 is a process of determining whether or not the voxel density of the mud object has been updated through a process in step S32 described later regarding the race object, during the process in the previous frame. When the determination result in step S27 is positive, the process in step S28 is executed. When the determination result in step S27 is negative, the process in step S27 is executed.

In step S28, the processor 81 sets the movement speed of the race object to a speed used when deforming the mud object. In the exemplary embodiment, the speed when deforming the mud object is lower than the normal speed (step S29 described below). The processor 81 updates the object data stored in the memory for the race object so that the data indicates the set speed. After step S28, the processor 81 ends the speed calculation process.

In step S29, the processor 81 sets the movement speed of the race object to a predetermined normal speed. The processor 81 updates the object data stored in the memory for the race object so that the data indicates the set speed. After step S29, the processor 81 ends the speed calculation process.

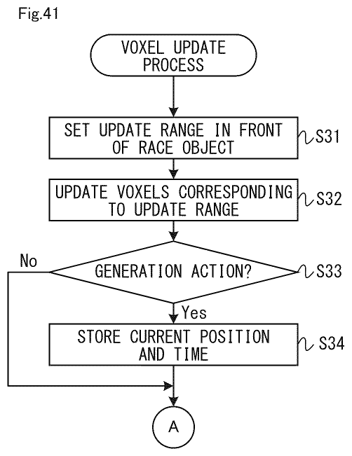

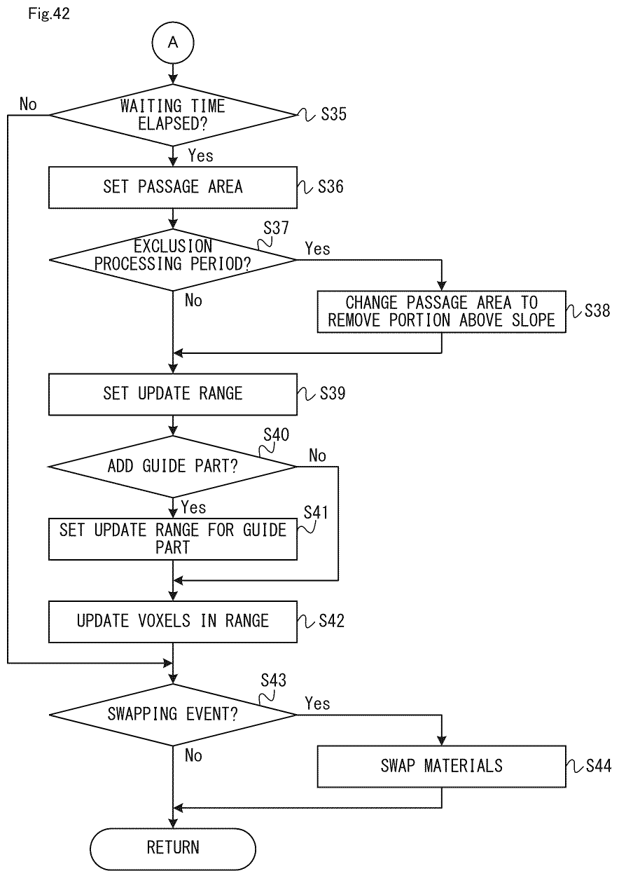

The speed calculation process in step S2 shown in FIG. 39 is followed by the process in step S3. In step S3, the processor 81 performs a voxel update process of updating the voxel data. Hereinafter, the voxel update process in step S3 will be described in detail with reference to FIG. 41 and FIG. 42.

FIG. 41 and FIG. 42 are sub flowcharts showing an example of a specific flow of the voxel update process in step S3 shown in FIG. 39. In the voxel update process, first, in step S31, the processor 81 sets a voxel update range in front of the race object designated in step S2. For example, the processor 81 updates the voxel update range data stored in the memory so that data indicating a spherical region centered at a position located a predetermined distance ahead of the race object is included. Next to step S31, the process in step S32 is executed.

In step S32, the processor 81 updates the densities of voxels corresponding to the voxel update range set in step S31. Specifically, the processor 81 updates the voxel data stored in the memory so that the density of the voxel is decreased (e.g., to 0). Thus, if a voxel mesh is placed within the voxel update range, the voxel mesh is deformed such that a portion, of the voxel object, within the voxel update range is deleted, through processes in steps S5 to S8 described below. In the exemplary embodiment, the voxel objects deformed through the process in step S32 are the soil object and the mud object, and the traveling road object is not deformed through the process in step S32. For example, the processor 81 may perform density update when the material set for the voxels corresponding to the voxel update range is the soil or mud material, and may not perform density update when it is the traveling road material. Moreover, for example, a voxel space for the traveling road object may be set separately from the voxel space for the soil object and the mud object. Next to step S32, the process in step S33 is executed.

In step S33, the processor 81 determines whether or not the race object is performing a generation action. When the determination result in step S33 is positive, the process in step S34 is executed. When the determination result in step S33 is negative, the process in step S35 shown in FIG. 42 is executed.

In step S34, the processor 81 stores the current position of the race object in association with the current time. In the exemplary embodiment, the current position is a position obtained by moving the position calculated in the process in the previous frame, in a direction according to the operation input performed by the player, by a distance based on the movement speed set in step S2. However, in other embodiments, the position calculated in the process in the previous frame may be used as the current position. The processor 81 updates the position history data stored in the memory so that data indicating the current position and data capable of specifying the elapsed time from the start of the generation action are included. Next to step S34, the process in step S35 shown in FIG. 42 is executed.

In step S35, the processor 81 determines whether or not any of the positions of the race object indicated by the position history data stored in the memory has passed the above waiting period. For example, the determination in step S35 is made based on whether or not the position history data includes data indicating a position associated with an elapsed time equal to or greater than the waiting time. When the determination result in step S35 is positive, the process in step S36 is executed. When the determination result in step S35 is negative, the process in step S43 is executed.

In step S36, based on the position of the race object determined in step S35 to have passed the waiting period, the processor 81 sets a passage area that extends from a position one frame before this position to this position. Next to step S36, the process in step S37 is executed.

In step S37, the processor 81 determines whether or not the elapsed time associated with the position of the race object determined in step S35 to have passed the waiting period is within the above exclusion processing period from the start of the generation action. When the determination result in step S37 is positive, the process in step S36 is executed. When the determination result in step S37 is negative, the process in step S39 is executed.

In step S38, the processor 81 changes the passage area set in step S36 such that a portion, of the passage area, above the slope set regarding the passage area is excluded. The slope is set according to the method described in the above [2-8. Game example]. Next to step S38, the process in step S39 is executed.

In step S39, the processor 81 sets a voxel update range based on a passage area. Here, the passage area used for setting the voxel update range is the passage area set in step S36 if the process in step S38 is not executed, and is the passage area changed in step S38 if the process in step S38 is executed. Specifically, the processor 81 updates the voxel update range data stored in the memory so that data indicating the passage area is included. Thus, a voxel update range corresponding to the traveling surface part of the traveling road object is set. In step S39, the processor 81 deletes the data indicating the position of the race object, used for setting the voxel update range, from the position history data stored in the memory. Next to step S39, the process in step S40 is executed.

In step S40, the processor 81 determines whether or not to add a guide part of the traveling road object. The determination in step S40 is made based on, for example, whether or not the current time is before a predetermined time has elapsed from the start of the generation action, or whether or not the current position of the race object is within a predetermined distance from the start position of the generation action. When the determination result in step S40 is positive, the process in step S41 is executed. When the determination result in step S40 is negative, the process in step S42 is executed.

In step S41, the processor 81 sets a voxel update range corresponding to the guide part. The voxel update range set in step S41 may have, for example, a predetermined shape that is determined based on the distance from the start position of the generation action to the current position of the race object. The processor 81 updates the voxel update range data stored in the memory so that data indicating the set voxel update range is included. Next to step S41, the process in step S42 is executed.

In step S42, the processor 81 updates the voxel corresponding to the voxel update range set in steps S39 and S41. Specifically, the processor 81 updates the voxel so that the density thereof is increased, and the material of the voxel becomes the traveling road material. The processor 81 updates the voxel data stored in the memory so that the data indicates the updated density and material of the voxel. Thus, the mesh of the traveling road object is deformed such that the traveling road object has a shape having the voxel update range inside, through the processes in steps S5 to S8. Next to step S42, the process in step S43 is executed.

In the example of processes shown in FIG. 41 and FIG. 42, in a frame in which a generation action is performed, the current position of the race object at that point in time is stored (step S34), and setting of a passage area (steps S36, S38), setting of a voxel update range (step S39), and voxel update (step S42) are performed based on the stored position, in a frame after the waiting period has elapsed. The process of updating the traveling road object after the waiting period has elapsed is not limited to the above process. For example, in other embodiments, the processor 81, in a frame in which a generation action is performed, may set and store a passage area based on the position of the race object at that point in time, and in a frame after the waiting period has elapsed, may set a voxel update range and perform voxel update based on the stored passage area. Alternatively, for example, the processor 81, in a frame in which a generation action is performed, may perform setting of a passage area and setting of a voxel update range based on the position of the race object at that point in time and store the voxel update range, and in a frame after a waiting period has elapsed, may perform voxel update based on the stored voxel update range.

In step S43, the processor 81 determines whether or not a swap event has occurred. In the exemplary embodiment, the determination in step S43 is performed by determining whether or not the race object has passed a swap object. When the determination result in step S43 is positive, the process in step S44 is executed. When the determination result in step S43 is negative, the processor 81 ends the voxel update process.

In step S44, the processor 81 swaps the materials of the soil object and the mud object. Specifically, the processor 81 updates the material data stored in the memory so that the ID of the soil material and the ID of the mud material are swapped. Thus, through processes in steps S5 to S8 described below, a voxel object, and a voxel object that previously had the mud material assigned now has the soil material assigned. After step S44, the processor 81 ends the voxel update process.

Next to voxel update process in step S3 shown in FIG. 38, the process in step S4 is executed. In step S4, the processor 81 determines whether or not all the objects to be processed have been subjected to the processes in step S2 to S3. When the determination result in step S4 is positive, the process in step S5 is executed. When the determination result in step S4 is negative, the process in step S2 is again executed.

In the flowchart shown in FIG. 38, the race object is subjected to the processes in steps S2 and S3, and other objects may also be subjected to the movement speed calculation process and the voxel update process. In other embodiments, as for the objects to be subjected to the processes in steps S2 and S3, the processor 81 may perform a process of providing (e.g., reflecting) the result of contact of the objects in the previous frame. This process includes a process in which, if collision determination (step S9 described below) in the previous frame determines that objects have come into contact with each other, an effect caused by the contact is applied to the respective objects. This process includes the following processes, for example.
A process of reducing the hit points of the player object when it is determined that another object has come into contact with the player object.
A process of generating a fragment object when it is determined that a race object has come into contact with the soil object or the mud object in the previous frame.
A process of disappearing a fragment object when it is determined that the fragment object has come into contact with another object in the previous frame.

In step S5, the processor 81 updates the vertices of the voxel object in the game space. That is, when the voxel data has been updated in the process in step S3, new vertices are calculated based on the updated voxel data. The positions of the new vertices are calculated according to the method described in the above [2-3. Calculation of vertices]. In addition, materials of the new vertices are calculated according to the method described in the above [2-4. Determination of material of vertex]. Next to step S5, the process in step S6 is executed.

In step S6, the processor 81 performs simplification for the vertices. That is, the processor 81 performs simplification for the vertices updated in the process in step S5, according to the method described in the above [2-5. Simplification of vertices]. The SVO data stored in the memory is updated so as to indicate the vertices obtained through the processes in steps S5 and S6. Therefore, update of the SVO data is performed through the processes in steps S5 and S6. The processes in steps S5 and S6 may not necessarily calculate new vertices for the entirety of the voxel data, and may be performed only for the part in which the content of the voxels has been changed in the process in step S3. Next to step S6, the process in step S7 is executed.

In step S7, the processor 81 updates the display mesh of the voxel object, based on the SVO data stored in the memory. The positions of the vertices of the display mesh and the materials of the polygons in the display mesh (e.g., the materials set for the vertices of the polygons) are calculated according to the method described in the above [2-6. Generation of mesh] and [2-6-1. Determination of material of display mesh]. The processor 81 updates the display mesh data stored in the memory so as to indicate the positions and materials of the vertices of the updated display mesh. Next to step S7, the process in step S8 is executed. The processor 81 may start the process in step S8 and subsequent steps without waiting for completion of step S7 to execute these steps in parallel with step S7. In this case, step S7 needs to be completed before start of step S12.

In step S8, the processor 81 updates the determination mesh of the voxel object, based on the SVO data stored in the memory. The positions of the vertices of the determination mesh and the materials of the polygons in the determination mesh (e.g., the materials set for the vertices of the polygons) are calculated according to the method described in the above [2-6. Generation of mesh] and [2-6-2. Determination of material of determination mesh]. The processor 81 updates the determination mesh data stored in the memory so as to indicate the positions and materials of the vertices of the updated determination mesh. Next to step S8, the process in step S9 is executed.

In the example shown in FIG. 39, the determination mesh generation process (step S8) is executed for each frame, but the determination mesh generation process may not necessarily be executed for each frame. For example, in the case where the collision determination process in step S9 is executed only for a frame that satisfies a predetermined condition, the processor 81 may execute the determination mesh generation process in the frame in which the collision determination in step S9 is performed. In addition, the processor 81 may execute the determination mesh generation process for voxels in a region, in the game space, where the collision determination in step S9 is performed. For example, in a situation where, in the game space, an object to be subjected to collision determination does not exist around the player character, except for a voxel object (e.g., a situation where only collision determination between the player character and the neighboring voxel object needs to be performed), the processor 81 may execute the determination mesh generation process for voxels within a predetermined range based on the player character.

In step S9, the processor 81 performs collision determination for each object in the game space, based on the determination mesh data and the object data stored in the memory. That is, the processor 81 performs collision determination by using a determination mesh for a voxel object, and using, for an object that is not a voxel object, a determination region having a predetermined shape, which is set for the object. In the exemplary embodiment, the collision determination in step S9 is performed in consideration of the speed calculated in step S2. That is, the processor 81 performs collision determination by using, as the position of the object, a position obtained by moving the position of the object in the previous frame by a distance based on the above movement speed. In the exemplary embodiment, the collision determination in step S9 determines, for example, whether or not race objects have come into contact with each other, or whether or not a race object and a traveling road object have come into contact with each other. If the result of the collision determination in step S9 is that the objects have come into contact with each other, a process of providing the result of the contact of the objects is executed in the process in step S2 in the next frame. Next to step S9, the process in step S10 is executed.

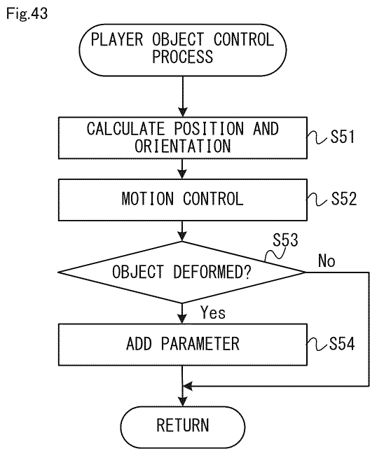

In step S10, the processor 81 performs a player object control process. Hereinafter, the player object control process in step S10 will be described in detail with reference to FIG. 43.

FIG. 43 is a sub flowchart showing an example of a specific flow of the player object control process in step S10 shown in FIG. 39. In the player object control process, first, in step S31, the processor 81 calculates the position and orientation of the player object. For example, the position of the player object is calculated as a position obtained by moving the position calculated in the process in the previous frame, in a traveling direction according to the operation input performed by the player, by a distance based on the movement speed set in step S2. The orientation of the player object is determined according to the above traveling direction. The processor 81 may use the position calculated in step S34 as the position of the player object. The processor 81 updates the object data stored in the memory for the player object so that the content of the data indicates the calculated position and orientation. Next to step S51, the process in step S52 is executed.

In step S52, the processor 81 controls the motion of the player object. For example, the processor 81 causes the player object to perform a motion based on the state of the player object, such as a motion during a generation action or a motion during traveling on a traveling road object. In a single execution of step S52, the processor 81 controls the player object such that, for a motion that spans a plurality of frames, the motion is advanced by one frame. The object data stored in the memory is updated so as to indicate the object after the control in step S52. Next to step S52, the process in step S53 is executed.

In step S53, the processor 81 determines whether or not the player object has deformed the soil object or the mud object. The determination in step S53 is performed depending on, for example, whether or not the densities of voxels in the voxel update range have been changed, in step S32 in the above voxel update process (step S3). When the determination result in step S53 is positive, the process in step S54 is executed. When the determination result in step S53 is negative, the processor 81 ends the player object control process.

In step S54, the processor 81 adds an action parameter of the player object. Specifically, the processor 81 updates the action parameter data stored in the memory for the player object so that a predetermined amount is added to the value before the update. After step S54, the processor 81 ends the player object control process.

The player object control process in step S10 shown in FIG. 43 is followed by the process in step S11. In step S11, the processor 81 controls the motions of objects other than the player object. For example, as for the race objects, the processor 81 performs the same process as the player object control process in step S10 for each race object. However, for the race object other than the player object, its traveling direction is determined based on the control rules defined in the game program, instead of an operation input performed by the player. Furthermore, as for objects other than the race objects, the processor 81 controls the motion of each object, based on the control rules defined in the game program. In a single execution of step S10, the processor 81 controls the object such that, for a motion that spans a plurality of frames, the motion is advanced by one frame. The object data stored in the memory is updated so as to indicate the object after the control in step S10. Next to step S11, the process in step S12 is executed.

In step S12, the processor 81 generates a game image. That is, the processor 81 generates a game image by performing rendering, based on the virtual camera, for the polygons of the display mesh of the voxel object, and the polygons of objects other than the voxel object. The polygons of the display mesh are rendered by using rendering setting such as textures corresponding to materials set for the polygons, according to the method described in the above [2-6-1. Determination of material of display mesh]. Furthermore, the processor 81 renders the gauge image, the effect image, and the like according to need. The game image generated in step S12 is outputted to the display device and displayed in a cycle of once for each frame. Next to step S12, the process in step S13 is executed.

In step S13, the processor 81 determines whether or not to end the game. For example, the processor 81 determines to end the game when a predetermined operation input to end the game has been performed by the player. When the determination result in step S13 is negative, the process in step S1 is executed again. Thereafter, a series of processes in steps S1 to S13 is repeated until the processor 81 determines to end the game in step S13. When the determination result in step S13 is positive, the processor 81 ends the game processing shown in FIG. 39.

### 4. Functions and Effects of Exemplary Embodiment and Modifications

In the above exemplary embodiment, the game system 1 decreases the densities of voxels corresponding to the first voxel update range that is set in front of the player object, and increases the densities of voxels corresponding to the second voxel update range that is set at a position through which the player object performing a predetermined action has passed. Thus, a novel game in which a voxel mesh dynamically deforms in response to movement of the player object can be provided.

In the above exemplary embodiment, the game system 1 generates both the display mesh and the determination mesh described above, and deforms both the display mesh and the determination mesh using the first and second voxel update ranges. However, in other embodiments, a single type of mesh that is used for both display and collision determination may be generated, and the game system 1 may deform such a single type of mesh by using the first and second voxel update ranges. Furthermore, for example, the game system 1 may deform the determination mesh by using the first and second voxel update ranges, and may deform the display mesh by using any method.

In the above [2-8. Game example], the case where a racing game is performed is described as an example. However, the process of deforming a voxel mesh by using the first and second voxel update ranges may be executed in any other type of game different from a racing game.

In the above exemplary embodiment, when a process is executed by using data (including a program) in a certain information processing apparatus, a part of the data required for the process may be transmitted from another information processing apparatus different from the certain information processing apparatus. In this case, the certain information processing apparatus may execute the process by using the data received from the other information processing apparatus and the data stored therein.

In other embodiments, the information processing system may not include some of the components in the above embodiment, and may not execute some of the processes executed in the above embodiment. For example, in order to obtain a result of a part of the above embodiment, the information processing system includes a configuration for obtaining the result and executes a process for obtaining the result, and need not include other configurations and need not execute other processes.

The above exemplary embodiment can be used as, for example, a game system or a game program for the purpose of, for example, providing a novel game using voxel data.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to execute information processing comprising:
updating, based on game processing, voxel data which is defined in a virtual space and in which at least a density is set for each of a plurality of voxels, the density indicating a degree of occupation of a content in a space defined by the voxel;
updating a voxel mesh which is a mesh corresponding to the voxel data, and vertex coordinates of which are determined based on at least the density included in the voxel data; and
in the game processing,
when a player object in the virtual space is on the voxel mesh, controlling movement of the player object based on an operation input at a position on the voxel mesh,
generating a first voxel update range in front of the player object, and decreasing the densities of voxels corresponding to the first voxel update range,
causing the player object to perform a first action in response to a first instruction based on the operation input, and
generating a second voxel update range continuously at positions passed by the player object through the first action, and increasing the densities of voxels corresponding to the second voxel update range.

2. The one or more non-transitory computer-readable storage media according to claim 1, wherein
the game processing is for a racing game in which the player object completes a plurality of laps around an annular course in a field within the virtual space.

3. The one or more non-transitory computer-readable storage media according to claim 2, wherein
the course in the field includes a ground object having a mesh other than the voxel mesh,
the voxel data is defined in at least a range above the ground object in the virtual space, and
the information processing further comprises controlling movement of the player object in the virtual space, based on an operation input at the position on the ground object, when the player object is on the ground object.

4. The one or more non-transitory computer-readable storage media according to claim 1, wherein
in the voxel data, a material indicating the type of the content is set for each of the plurality of voxels, and
the information processing further comprises:
generating or updating a material of the voxel mesh by determining the material based on at least the material included in the voxel data;
updating, to a first material, the material of a voxel the density of which is increased based on the second voxel update range; and
accelerating the player object when the player object is on the voxel mesh the material of which is the first material.

5. The one or more non-transitory computer-readable storage media according to claim 1, wherein
in the voxel data, a material indicating the type of the content is set for each of the plurality of voxels, and
the information processing further comprises:
generating or updating a material of the voxel mesh by determining the material based on at least the material included in the voxel data; and
when the material of the voxel mesh in a traveling direction of the player object is a second material, reducing a movement speed of the player object in the movement control more than when the material of the voxel mesh is a third material.

6. The one or more non-transitory computer-readable storage media according to claim 5, wherein
the information processing further comprises, when a first event has occurred during the game processing, swapping the type of the content indicated by the second material and the type of the content indicated by the third material with each other.

7. The one or more non-transitory computer-readable storage media according to claim 1, wherein
the information processing further comprises generating the second voxel update range after a certain period has elapsed from when the player object passed.

8. The one or more non-transitory computer-readable storage media according to claim 1, wherein
the first action is an action including at least a jump in a traveling direction, and
the information processing further comprises:
during a first period after start of the first action, setting, as the second voxel update range, a range obtained by excluding a portion, of a third voxel update range set at a position passed by the player object, located above a plane obtained by a certain angle inclining a plane from a start position of the first action to a current position of the player object; and
after the first period has elapsed, setting the third voxel update range as the second voxel update range.

9. The one or more non-transitory computer-readable storage media according to claim 8, wherein
the information processing further comprises, when the first action is started, generating a fourth voxel update range outside the second voxel update range, and increasing the densities of voxels corresponding to the fourth voxel update range.

10. The one or more non-transitory computer-readable storage media according to claim 1, wherein
the voxel mesh includes a collision mesh used for collision determination with the player object and a display mesh rendered based on a virtual camera, or serves both as the collision mesh and as the display mesh,
in the voxel data, a material indicating the type of the content is set for each of the plurality of voxels, and
the information processing further comprises:
determining a material of the collision mesh, based on at least the material included in the voxel data; and
using the collision mesh as the display mesh, rendering the virtual space including the display mesh, based on a texture corresponding to vertex coordinates of the display mesh and the material of the display mesh.

11. The one or more non-transitory computer-readable storage media according to claim 1, wherein
the voxel mesh is a collision mesh used for collision determination with the player object,
in the voxel data, a material indicating the type of the content is set for each of the plurality of voxels, and
the information processing further comprises:
generating or updating a display mesh which corresponds to the voxel data and is rendered based on a virtual camera, by determining vertex coordinates of the display mesh, based on at least the density included in the voxel data, and determining a material of the display mesh, based on at least the material included in the voxel data; and
rendering the virtual space including the display mesh, based on a texture corresponding to the vertex coordinates of the display mesh and the material of the display mesh.

12. An information processing system comprising:
one or more processors, and
one or more memories having stored therein computer-executable instructions to execute information processing comprising:
updating, based on game processing, voxel data which is defined in a virtual space and in which at least a density is set for each of a plurality of voxels, the density indicating a degree of occupation of a content in a space defined by the voxel;
updating a voxel mesh which is a mesh corresponding to the voxel data, and vertex coordinates of which are determined based on at least the density included in the voxel data; and
in the game processing,
when a player object in the virtual space is on the voxel mesh, controlling movement of the player object based on an operation input at a position on the voxel mesh,
generating a first voxel update range in front of the player object, and decreasing the densities of voxels corresponding to the first voxel update range,
causing the player object to perform a first action in response to a first instruction based on the operation input, and
generating a second voxel update range continuously at positions passed by the player object through the first action, and increasing the densities of voxels corresponding to the second voxel update range.

13. The information processing system according to claim 12, wherein
the game processing is for a racing game in which the player object completes a plurality of laps around an annular course in a field within the virtual space.

14. The information processing system according to claim 13, wherein
the course in the field includes a ground object having a mesh other than the voxel mesh,
the voxel data is defined in at least a range above the ground object in the virtual space, and
the information processing further comprises controlling movement of the player object in the virtual space, based on an operation input at the position on the ground object, when the player object is on the ground object.

15. The information processing system according to claim 12, wherein
in the voxel data, a material indicating the type of the content is set for each of the plurality of voxels, and
the information processing further comprises:
generating or updating a material of the voxel mesh by determining the material based on at least the material included in the voxel data;
updating, to a first material, the material of a voxel the density of which is increased based on the second voxel update range; and
accelerating the player object when the player object is on the voxel mesh the material of which is the first material.

16. The information processing system according to claim 12, wherein
in the voxel data, a material indicating the type of the content is set for each of the plurality of voxels, and
the information processing further comprises:
generating or updating a material of the voxel mesh by determining the material based on at least the material included in the voxel data; and
when the material of the voxel mesh in a traveling direction of the player object is a second material, reducing a movement speed of the player object in the movement control more than when the material of the voxel mesh is a third material.

17. The information processing system according to claim 16, wherein
the information processing further comprises, when a first event has occurred during the game processing, swapping the type of the content indicated by the second material and the type of the content indicated by the third material with each other.

18. The information processing system according to claim 12, wherein
the information processing further comprises generating the second voxel update range after a certain period has elapsed from when the player object passed.

19. The information processing system according to claim 12, wherein
the first action is an action including at least a jump in a traveling direction, and
the information processing further comprises:
during a first period after start of the first action, setting, as the second voxel update range, a range obtained by excluding a portion, of a third voxel update range set at a position passed by the player object, located above a plane obtained by a certain angle inclining a plane from a start position of the first action to a current position of the player object; and
after the first period has elapsed, setting the third voxel update range as the second voxel update range.

20. The information processing system according to claim 19, wherein
the information processing further comprises, when the first action is started, generating a fourth voxel update range outside the second voxel update range, and increasing the densities of voxels corresponding to the fourth voxel update range.

21. The information processing system according to claim 12, wherein
the voxel mesh includes a collision mesh used for collision determination with the player object and a display mesh rendered based on a virtual camera, or serves both as the collision mesh and as the display mesh,
in the voxel data, a material indicating the type of the content is set for each of the plurality of voxels, and
the information processing further comprises:
determining a material of the collision mesh, based on at least the material included in the voxel data; and
using the collision mesh as the display mesh, rendering the virtual space including the display mesh, based on a texture corresponding to vertex coordinates of the display mesh and the material of the display mesh.

22. The information processing system according to claim 12, wherein
the voxel mesh is a collision mesh used for collision determination with the player object,
in the voxel data, a material indicating the type of the content is set for each of the plurality of voxels, and
the information processing further comprises:
generating or updating a display mesh which corresponds to the voxel data and is rendered based on a virtual camera, by determining vertex coordinates of the display mesh, based on at least the density included in the voxel data, and determining a material of the display mesh, based on at least the material included in the voxel data; and
rendering the virtual space including the display mesh, based on a texture corresponding to the vertex coordinates of the display mesh and the material of the display mesh.

23. A computer-implemented method comprising:
updating, based on game processing, voxel data which is defined in a virtual space and in which at least a density is set for each of a plurality of voxels, the density indicating a degree of occupation of a content in a space defined by the voxel;
updating a voxel mesh which is a mesh corresponding to the voxel data, and vertex coordinates of which are determined based on at least the density included in the voxel data; and
in the game processing,
when a player object in the virtual space is on the voxel mesh, controlling movement of the player object based on an operation input at a position on the voxel mesh,
generating a first voxel update range in front of the player object, and decreasing the densities of voxels corresponding to the first voxel update range,
causing the player object to perform a first action in response to a first instruction based on the operation input, and
generating a second voxel update range continuously at positions passed by the player object through the first action, and increasing the densities of voxels corresponding to the second voxel update range.

24. The computer-implemented method according to claim 23, wherein
the game processing is for a racing game in which the player object completes a plurality of laps around an annular course in a field within the virtual space.

25. The computer-implemented method according to claim 24, wherein
the course in the field includes a ground object having a mesh other than the voxel mesh,
the voxel data is defined in at least a range above the ground object in the virtual space, and
the computer-implemented method further comprises controlling movement of the player object in the virtual space, based on an operation input at the position on the ground object, when the player object is on the ground object.

26. The computer-implemented method according to claim 23, wherein
in the voxel data, a material indicating the type of the content is set for each of the plurality of voxels, and
the computer-implemented method further comprises:
generating or updating a material of the voxel mesh by determining the material based on at least the material included in the voxel data;
updating, to a first material, the material of a voxel the density of which is increased based on the second voxel update range; and
accelerating the player object when the player object is on the voxel mesh the material of which is the first material.

27. The computer-implemented method according to claim 23, wherein
in the voxel data, a material indicating the type of the content is set for each of the plurality of voxels, and
the computer-implemented method further comprises:
generating or updating a material of the voxel mesh by determining the material based on at least the material included in the voxel data; and
when the material of the voxel mesh in a traveling direction of the player object is a second material, reducing a movement speed of the player object in the movement control more than when the material of the voxel mesh is a third material.

28. The computer-implemented method according to claim 27, further comprises, when a first event has occurred during the game processing, swapping the type of the content indicated by the second material and the type of the content indicated by the third material with each other.

29. The computer-implemented method according to claim 23, further comprises generating the second voxel update range after a certain period has elapsed from when the player object passed.

30. The computer-implemented method according to claim 23, wherein
the first action is an action including at least a jump in a traveling direction, and
the computer-implemented method further comprises:
during a first period after start of the first action, setting, as the second voxel update range, a range obtained by excluding a portion, of a third voxel update range set at a position passed by the player object, located above a plane obtained by a certain angle inclining a plane from a start position of the first action to a current position of the player object; and
after the first period has elapsed, setting the third voxel update range as the second voxel update range.

31. The computer-implemented method according to claim 30, further comprises, when the first action is started, generating a fourth voxel update range outside the second voxel update range, and increasing the densities of voxels corresponding to the fourth voxel update range.

32. The computer-implemented method according to claim 23, wherein
the voxel mesh includes a collision mesh used for collision determination with the player object and a display mesh rendered based on a virtual camera, or serves both as the collision mesh and as the display mesh,
in the voxel data, a material indicating the type of the content is set for each of the plurality of voxels, and
the computer-implemented method further comprises:
determining a material of the collision mesh, based on at least the material included in the voxel data; and
using the collision mesh as the display mesh, rendering the virtual space including the display mesh, based on a texture corresponding to vertex coordinates of the display mesh and the material of the display mesh.

33. The computer-implemented method according to claim 23, wherein
the voxel mesh is a collision mesh used for collision determination with the player object,
in the voxel data, a material indicating the type of the content is set for each of the plurality of voxels, and
the computer-implemented method further comprises:
generating or updating a display mesh which corresponds to the voxel data and is rendered based on a virtual camera, by determining vertex coordinates of the display mesh, based on at least the density included in the voxel data, and determining a material of the display mesh, based on at least the material included in the voxel data; and
rendering the virtual space including the display mesh, based on a texture corresponding to the vertex coordinates of the display mesh and the material of the display mesh.
